(19) United States
(12) Patent Application Publication
(10) Pub. No.: US 2025/0007665 A1
(43) Pub. Date: Jan. 2, 2025

(54) TECHNIQUES TO FACILITATE PRIORITY RULES FOR MEASUREMENTS BASED ON CELL-DEFINING SSBS AND/OR NON-CELL-DEFINING SSBS

(71) Applicant: QUALCOMM Incorporated, San Diego, CA (US)

(72) Inventors: Jing LEI, San Diego, CA (US); Chao WEI, Beijing (CN); Peter GAAL, San Diego, CA (US)

(21) Appl. No.: 18/697,714

(22) PCT Filed: Dec. 2, 2022
(86) PCT No.: PCT/CN2022/136177

§ 371 Date: Apr. 1, 2024

(30) Foreign Application Priority Data
Dec. 3, 2021 (WO) PCT/CN2021/135450

(51) Int. Cl. H04L 5/00; H04L 5/14; H04W 72/0453; H04W 72/51

(52) U.S. Cl. CPC H04L 5/005; H04L 5/0094; H04L 5/0096; H04L 5/14; H04W 72/0453; H04W 72/51

(57) ABSTRACT

Apparatus, methods, and computer-readable media for facilitating priority rules for measurements based on CD-SSBs and/or NCD-SSBs are disclosed herein. An example method for wireless communication at a UE includes indicating a UE capability to a network. The example method also includes receiving a configuration for a measurement object and a DL BWP, the configuration indicating that the DL BWP includes a CD-SSB, includes an NCD-SSB, or that an SSB is absent. The configuration for the measurement object and the DL BWP may be based at least on one or more of a duplex mode type, a frequency range, a type of the DL BWP, or the UE capability.

### CROSS REFERENCE TO RELATED APPLICATION(S)

This application claims the benefit of and priority to PCT Application Serial No. PCT/CN2021/135450, entitled “TECHNIQUES TO FACILITATE PRIORITY RULES FOR MEASUREMENTS BASED ON CELL-DEFINING SSBS AND/OR NON-CELL-DEFINING SSBS,” and filed on Dec. 3, 2021, which is expressly incorporated by reference herein in its entirety.

### TECHNICAL FIELD

The present disclosure relates generally to communication systems, and more particularly, to wireless communication systems utilizing cell-defining (CD) synchronization signal blocks (SSBs) and non-cell-defining (NCD) SSBs.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication. An apparatus may include a user equipment (UE). The example apparatus may indicate a UE capability to a network. The example apparatus may also receive a configuration for a measurement object and a downlink (DL) bandwidth part (BWP) in system information or a radio resource control (RRC) message, the configuration indicating that the DL BWP includes a cell-defining synchronization signal block (CD-SSB), includes a non-CD-SSB (NCD-SSB), or that an SSB is absent. The configuration for the measurement object and the DL BWP may be based at least on one or more of a duplex mode type, a frequency range, a type of the DL BWP, or the UE capability.

In another aspect of the disclosure, a method, a computer-readable medium, and an apparatus are provided for wireless communication. An apparatus may include a network entity, such as a base station or a component of a base station. The example apparatus may receive an indication of a UE capability of at least one UE. The example apparatus may also configure serving cell measurement and one or more DL BWPs, a configuration for each DL BWP being based on at least one or more of a duplex mode type, a frequency range, a DL BWP type, or a UE capability.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates a resource diagram showing multiple BWPs, in accordance with various aspects of the present disclosure.

FIG. 5 illustrate an example diagram showing an initial downlink BWP that may be configured within a carrier bandwidth of a serving cell for reduced capability UEs, in accordance with various aspects of the present disclosure.

FIG. 6 illustrates an example master information block (MIB) message, in accordance with various aspects of the present disclosure.

FIG. 7 illustrates example diagrams showing SSB transmissions with respect to initial downlink BWPs and non-initial downlink BWPs that may be configured within a carrier bandwidth of a serving cell for a reduced capability UE, in accordance with various aspects of the present disclosure.

FIG. 8 illustrates example diagrams showing SSB transmissions with respect to initial downlink BWPs and non-initial downlink BWPs that may be configured within a carrier bandwidth of a serving cell for a non-reduced capability UE, in accordance with various aspects of the present disclosure.

FIG. 9 illustrates example diagrams showing multiplexing in time/frequency domain of CD-SSB bursts and NCD-SSB bursts, in accordance with various aspects of the present disclosure.

FIG. 10 illustrates an example communication flow between a network entity and a UE, in accordance with various aspects of the present disclosure.

FIG. 11 is a flowchart of a method of wireless communication at a UE, in accordance with the teachings disclosed herein.

FIG. 12 is a flowchart of a method of wireless communication at a UE, in accordance with the teachings disclosed herein.

FIG. 13 is a diagram illustrating an example of a hardware implementation for an example apparatus and/or network entity.

FIG. 14 is a flowchart of a method of wireless communication at a network entity, in accordance with the teachings disclosed herein.

FIG. 15 is a flowchart of a method of wireless communication at a network entity, in accordance with the teachings disclosed herein.

FIG. 16 is a diagram illustrating an example of a hardware implementation for an example network entity.

### DETAILED DESCRIPTION

Aspects disclosed herein provide techniques for different SSB transmission in the initial/non-initial downlink BWP of different UE types (e.g., a reduced capability UE or a non-reduced capability UE) when a cell allows different UE types to access the cell. That is, when a cell supports reduced capability UE and non-reduced capability UE co-existence, different SSB transmissions in the initial/non-initial downlink BWP of the different UE type may be supported. Additionally, aspects disclosed herein provide priority rules for SSB-based measurements (e.g., for random access channel occasion (RO) selection, time/frequency tracking, link recovery, radio resource management (RRM) measurements, radio link monitoring (RLM) measurements, beam failure detection (BFD) measurements, and other tasks).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

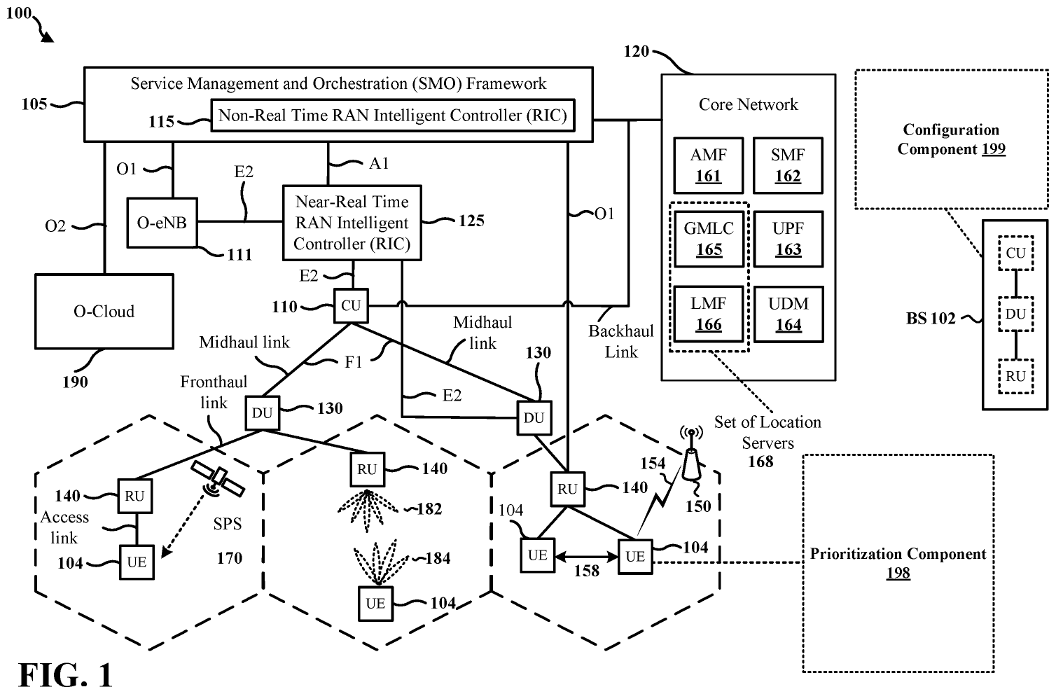

FIG. 1 is a diagram 100 illustrating an example of a wireless communications system and an access network. The illustrated wireless communications system includes a disaggregated base station architecture. The disaggregated base station architecture may include one or more CUs (e.g., a CU 110) that can communicate directly with a core network 120 via a backhaul link, or indirectly with the core network 120 through one or more disaggregated base station units (such as a Near-Real Time (Near-RT) RAN Intelligent Controller (RIC) (e.g., a Near-RT RIC 125) via an E2 link, or a Non-Real Time (Non-RT) RIC 115 associated with a Service Management and Orchestration (SMO) Framework (e.g., an SMO Framework 105), or both). A CU 110 may communicate with one or more DUs (e.g., a DU 130) via respective midhaul links, such as an F1 interface. The DU 130 may communicate with one or more RUs (e.g., an RU 140) via respective fronthaul links. The RU 140 may communicate with respective UEs (e.g., a UE 104) via one or more radio frequency (RF) access links. In some implementations, the UE 104 may be simultaneously served by multiple RUs.

Each of the units, i.e., the CUs (e.g., a CU 110), the DUs (e.g., a DU 130), the RUs (e.g., an RU 140), as well as the Near-RT RICs (e.g., the Near-RT RIC 125), the Non-RT RICs (e.g., the Non-RT RIC 115), and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 140 can be implemented to handle over the air (OTA) communication with one or more UEs (e.g., the UE 104). In some implementations, real-time and non-real-time aspects of control and user plane communication with the RU 140 can be controlled by a corresponding DU. In some scenarios, this configuration can enable the DU(s) and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as AI policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs (e.g., the RU 140) and the UEs (e.g., the UE 104) may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UE 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication (e.g., a D2D communication link 158). The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with a UE 104 (also referred to as Wi-Fi stations (STAs)) via communication link 154, e.g., in a 5 GHz unlicensed frequency spectrum or the like. When communicating in an unlicensed frequency spectrum, the UE 104/Wi-Fi AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) (e.g., an AMF 161), a Session Management Function (SMF) (e.g., an SMF 162), a User Plane Function (UPF) (e.g., a UPF 163), a Unified Data Management (UDM) (e.g., a UDM 164), one or more location servers 168, and other functional entities. The AMF 161 is the control node that processes the signaling between the UE 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) (e.g., a GMLC 165) and a Location Management Function (LMF) (e.g., an LMF 166). However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station (e.g., the base station 102). The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a device in communication with a base station, such as a UE 104 in communication with a network entity, such as a base station 102 or a component of a base station (e.g., a CU 110, a DU 130, and/or an RU 140), may be configured to manage one or more aspects of wireless communication. For example, the UE 104 may include a prioritization component 198 configured to facilitate applying priority rules for measurements based on CD-SSBs and/or NCD-SSBs.

In certain aspects, the prioritization component 198 may be configured to indicate a UE capability to a network. The example prioritization component 198 may also be configured to receive a configuration for a measurement object and a DL BWP in system information or an RRC message, the configuration indicating that the DL BWP includes a CD-SSB, includes an NCD-SS, or that an SSB is absent. The configuration for the measurement object and the DL BWP may be based at least on one or more of a duplex mode type, a frequency range, a type of the DL BWP, or the UE capability.

In another configuration, a network entity, such as a base station 102 or a component of a base station (e.g., a CU 110, a DU 130, and/or an RU 140), may be configured to manage or more aspects of wireless communication. For example, the base station 102 may include a configuration component 199 configured to facilitate applying priority rules for measurements based on CD-SSBs and/or NCD-SSBs.

In certain aspects, the configuration component 199 may be configured to receive an indication of a UE capability of at least one UE. The example configuration component 199 may also be configured to configure serving cell measurement and one or more DL BWPs, a configuration for each DL BWP being based on at least one or more of a duplex mode type, a frequency range, a DL BWP type, or a UE capability.

Although the following description may be focused on 5G NR, the concepts described herein may be applicable to other similar areas, such as 5G-advanced, 6G, LTE, LTE-A, CDMA, GSM, and other wireless technologies.

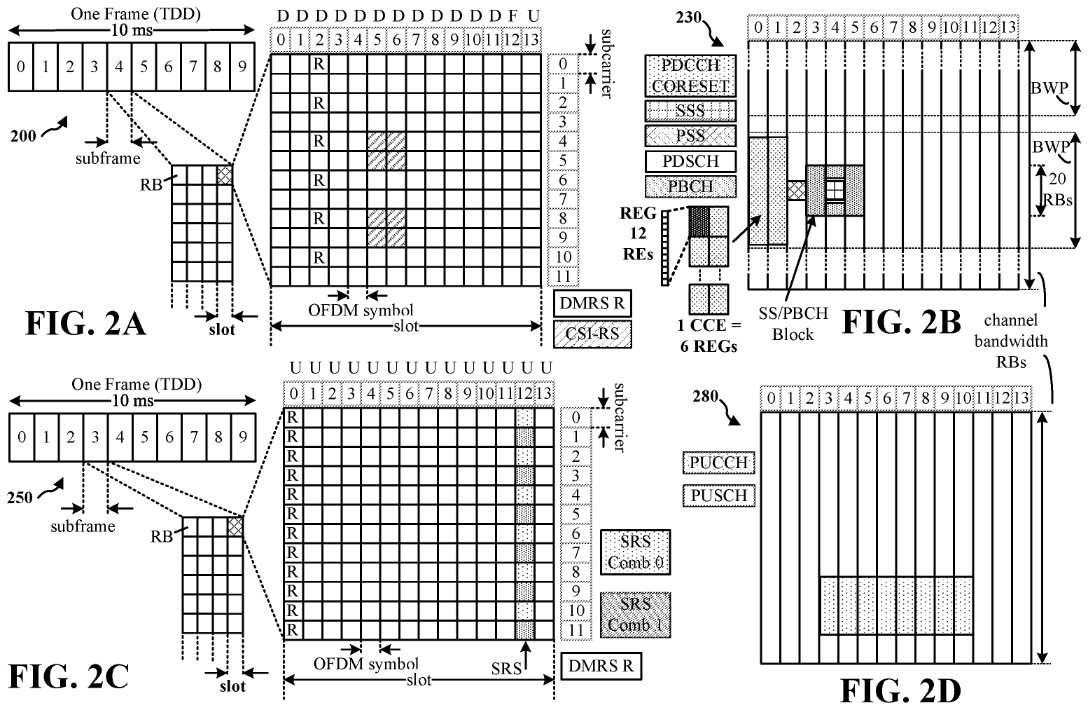

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2^{μ} slots/subframe. The subcarrier spacing may be equal to 2^{μ}*15 kHz, where μ is the numerology 0 to 4. As such, the numerology p=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

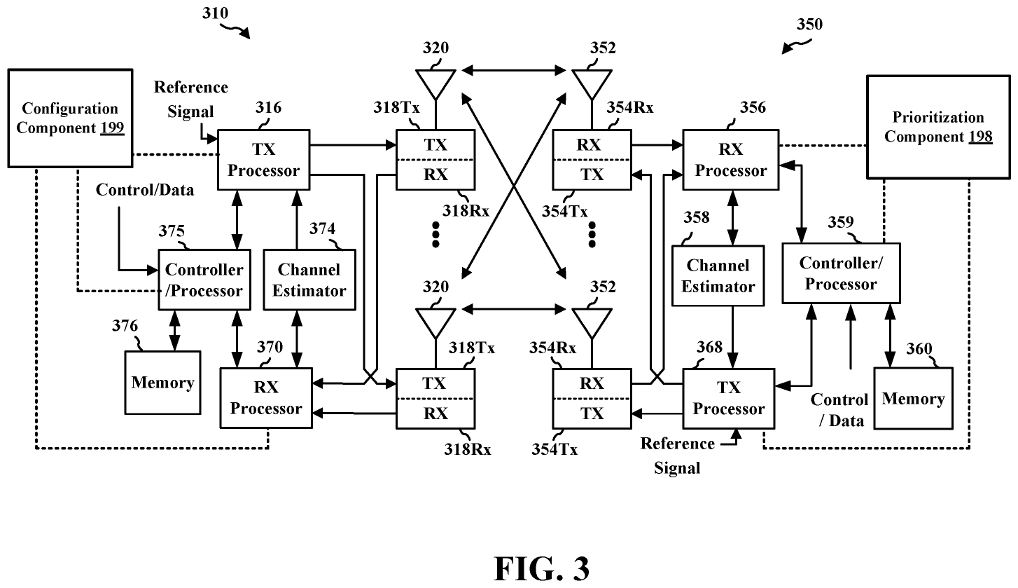

FIG. 3 is a block diagram that illustrates an example of a first wireless device that is configured to exchange wireless communication with a second wireless device. In the illustrated example of FIG. 3, the first wireless device may include a base station 310, the second wireless device may include a UE 350, and the base station 310 may be in communication with the UE 350 in an access network. As shown in FIG. 3, the base station 310 includes a transmit processor (TX processor 316), a transmitter 318Tx, a receiver 318Rx, antennas 320, a receive processor (RX processor 370), a channel estimator 374, a controller/processor 375, and memory 376. The example UE 350 includes antennas 352, a transmitter 354Tx, a receiver 354Rx, an RX processor 356, a channel estimator 358, a controller/processor 359, memory 360, and a TX processor 368. In other examples, the base station 310 and/or the UE 350 may include additional or alternative components.

In the DL, Internet protocol (IP) packets may be provided to the controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 316 and the RX processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna of the antennas 320 via a separate transmitter (e.g., the transmitter 318Tx). Each transmitter 318Tx may modulate a radio frequency (RF) carrier with a respective spatial stream for transmission.

At the UE 350, each receiver 354Rx receives a signal through its respective antenna of the antennas 352. Each receiver 354Rx recovers information modulated onto an RF carrier and provides the information to the RX processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, two or more of the multiple spatial streams may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with the memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna of the antennas 352 via separate transmitters (e.g., the transmitter 354Tx). Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna of the antennas 320. Each receiver 318Rx recovers information modulated onto an RF carrier and provides the information to the RX processor 370.

The controller/processor 375 can be associated with the memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the prioritization component 198 of FIG. 1.

At least one of the TX processor 316, the RX processor 370, and the controller/processor 375 may be configured to perform aspects in connection with the configuration component 199 of FIG. 1.

Wireless communication systems, such as NR communication systems, may support higher capability devices and reduced capability devices. Among others, examples of higher capability devices include premium smartphones, V2X devices, URLLC devices, eMBB devices, etc. Examples of reduced capability (RedCap) devices may include, among others, wearables (e.g., such as smart watches, augmented reality glasses, virtual reality glasses, health and medical monitoring devices, etc.), industrial wireless sensor networks (IWSN) (e.g., such as pressure sensors, humidity sensors, motion sensors, thermal sensors, accelerometers, actuators, etc.), surveillance cameras, low-end smartphones, etc. A reduced capability device may be referred to as an NR light device, a low-tier device, a lower tier device, etc.

A reduced capability UE may communicate based on various types of wireless communication. For example, smart wearables may transmit or receive communication based on low power wide area (LPWA)/mMTC, IoT devices may transmit or receive communication based on URLLC, sensors/cameras may transmit or receive communication based on eMBB, etc. In some examples, a reduced capability UE may have an uplink transmission power that is less than that of a higher capability UE. For example, a reduced capability UE may have an uplink transmission power of at least 10 dB less than that of a higher capability UE. As another example, a reduced capability UE may have reduced transmission bandwidth or reception bandwidth than other UEs. For instance, a reduced capability UE may have an operational bandwidth between 5 MHz and 20 MHz for both transmission and reception, in contrast to higher capability UEs that may have a bandwidth of up to 100 MHz. As an example, a reduced capability UE may have a maximum bandwidth of 20 MHz during and after initial access in FR1, and may have a maximum bandwidth of 100 MHz during and after initial access in FR2.

As a further example, a reduced capability UE may have a reduced number of reception antennas in comparison to other UEs. For frequency bands where a UE is equipped with at least two antennas, a minimum number of reception branches for a reduced capability UE may be 1, and may also include support for 2 reception branches. For frequency bands where a higher capability UE is equipped with four reception antenna ports, a minimum number of 1 reception branches may be supported, for example, with additional support for 2 reception branches for a reduced capability UE. In some aspects, a base station may know the number of reception branches at the UE. A reduced capability UE may have only a single receive antenna and may experience a lower equivalent receive signal to noise ratio (SNR) in comparison to higher capability UEs that may have multiple antennas. A reduced capability UE with 1 reception branch may support 1 downlink MIMO layer. A reduced capability UE with two reception branches may support two downlink MIMO layers. A maximum modulation order of 256 QAM may be supported in the downlink for an FR1 reduced capability UE. In some aspects, a reduced capability UE may support a half-duplex frequency division duplex (HD-FDD) type A duplex operation. A reduced capability UE may support a full-duplex FDD (FD-FDD) operation or a full-duplex time division duplex (FD-TDD) operation. Reduced capability UEs may additionally, or alternatively, have reduced computational complexity than other UEs.

As an example, a wearable may have a downlink heavy data rate, for example, of 5-50 Mbps on downlink compared to a rate of 2-5 Mbps on uplink, with peak rates of 150 Mbps on DL and 50 Mbps on UL. The latency and reliability may be based on eMBB. The battery life of the wearable may be intended to last for multiple days, for example, 1-2 weeks in one example. An industrial sensor may have uplink heavy data rates, for example, of around 2 Mbps, a latency of less than 100 ms with a smaller latency (e.g., 5-10 ms) for safety related sensors, a reliability of 99.9%, and may have a battery life that is intended to last for one or more years. A video surveillance device may have uplink heavy traffic, for example, with data rates of 2-4 Mbps for some traffic and 7.5-25 Mbps for higher priority traffic. The video surveillance device may have a latency of less than 500 ms with a reliability of 99%-99.9%.

It may be helpful for communication to be scalable and deployable in a more efficient and cost-effective way. For example, it may be possible to relax or reduce peak throughput, latency, and/or reliability requirements for the reduced capability devices. In some examples, reductions in power consumption, complexity, production cost, and/or reductions in system overhead may be prioritized. As an example, industrial sensors may have an acceptable latency up to approximately 100 ms. In some safety related applications, the latency of industrial wireless sensors may be acceptable up to 10 ms or up to 5 ms. The data rate may be lower and may include more uplink traffic than downlink traffic. As another example, video surveillance devices may have an acceptable latency up to approximately 500 ms.

Carrier bandwidth may span a contiguous set of PRBs, for example, from common resources blocks for a given numerology on a given carrier. A base station may configure one or more BWPs that have a smaller bandwidth span than the carrier bandwidth. One or more of the BWPs may be configured for downlink communication, and may be referred to as a DL BWP.

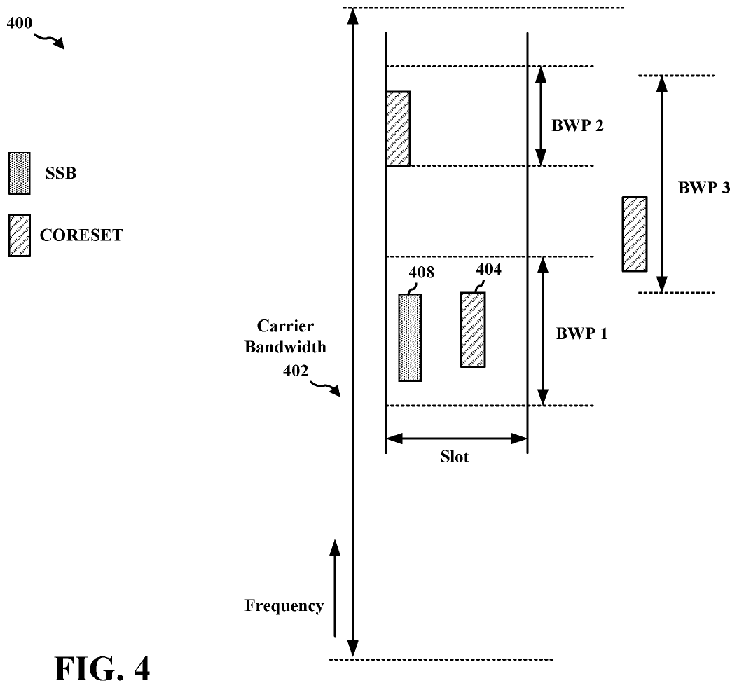

FIG. 4 illustrates a resource diagram 400 showing multiple BWPs (e.g., a BWP 1, a BWP 2, and a BWP 3) configured within a frequency span of a carrier bandwidth 402. One DL BWP may be active at a time, and the UE may not be expected to receive PDSCH, PDCCH, CSI-RS, or tracking RS (TRS) outside of an active BWP without a measurement gap or BWP switching gap. Each DL BWP may include at least one control resource set (CORESET). In FIG. 4, the BWPs may be DL BWPs and are illustrated as having a CORESET within the BWP. In other examples, the BWP may be an UL BWP and may not include a CORESET configuration. One or more of the BWPs may be configured for uplink communication, and may be referred to as an uplink (UL) BWP. One UL BWP may be active at a time for the UE, and the UE may not transmit PUSCH or PUCCH outside of the active BWP. The use of a BWP may reduce the bandwidth monitored by the UE and/or used for transmissions, which may help the UE to save battery power.

A CORESET corresponds to a set of physical resources in time and frequency that a UE uses to monitor for PDCCH/DCI. Each CORESET comprises one or more resource blocks in the frequency domain and one or more symbols in the time domain. As an example, a CORESET might comprise multiple RBs in the frequency domain and 1, 2, or 3 contiguous symbols in the time domain. A Resource Element (RE) is a unit indicating one subcarrier in frequency over a single symbol in time. A Control Channel Element (CCE) includes Resource Element Groups (REGs), e.g., 6 REGs, in which an REG may correspond to one RB (e.g., 12 REs) during one OFDM symbol. REGs within a CORESET may be numbered in increasing order in a time-first manner, starting with 0 for the first OFDM symbol and the lowest-numbered resource block in the control resource set. A UE can be configured with multiple CORESETs, each CORESET being associated with a CCE-to-REG mapping. A search space may comprise a set of CCEs, for example, at different aggregation levels. For example, the search space may indicate a number of candidates to be decoded, e.g., in which the UE performs decoding. A CORESET may comprise multiple search space sets.

In some aspects, UEs having different levels of capabilities, such as reduced capability UEs and non-reduced (or higher) capability UEs, may share an initial DL BWP (e.g., BWP 1) and CORESET #0 (e.g., a CORESET 404) for initial access. The UEs may monitor the resources of the CORESET 404 to receive system information that enables the UEs to perform initial access, for example. A cell-defining SSB (CD-SSB) may be transmitted within a bandwidth supported by the reduced capability UEs. As an example, the BWP 1 may be an initial DL BWP, e.g., which may be configured for both, reduced capability UEs and higher capability UEs. The UEs may be configured with a different BWP as an active DL BWP, e.g., after performing initial access. For example, in FIG. 4, the BWP 2 may be configured for lower capability UEs, and the higher capability UEs may be configured with the active DL BWP 3. FIG. 4 illustrates that the BWP 1 may include an SSB 408.

A network may output one or more synchronization signal blocks (SSBs) to a UE, and the UE may process (e.g., decode) the SSBs in order to obtain system information and begin communications with the network. An SSB may include synchronization signals, such as a PSS, a PBCH, and an SSS, which may be referred to as acquisition signals. The SSB may occupy resources in the time domain and/or the frequency domain. The PSS, the PBCH, and the SSS may each occupy different sets of symbols and subcarriers of the SSB.

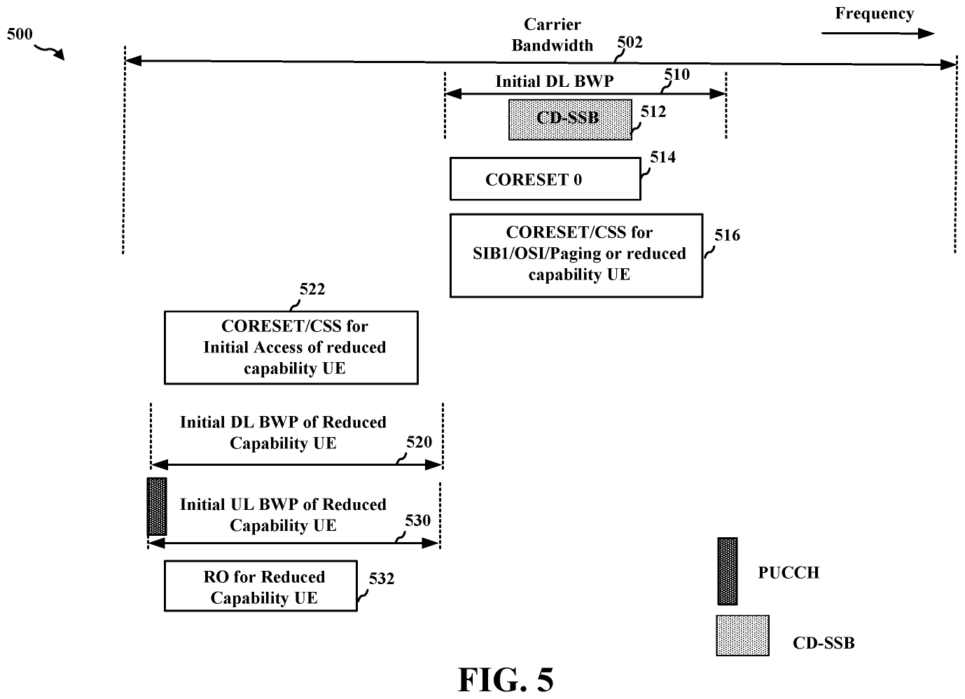

A cell that provides access to a reduced capability UE may configure a separate initial BWP for the reduced capability UE. FIG. 5 illustrate an example diagram 500 showing an initial downlink BWP 510 that may be configured within a carrier bandwidth 502 of a serving cell for reduced capability UEs to receive a CD-SSB, SI, paging information, etc. In some aspects, the initial downlink BWP 510 may be configured with resources for a CD-SSB 512, a CORESET #0 (e.g., a CORESET 514), and a CORESET or a common search space (CSS) (e.g., resources 516) for the UE to receive SIB1, other system information (OSI), or paging information. An idle or inactive reduced capability UE may camp on the initial downlink BWP 510, e.g., on the CORESET 514 of the serving cell to receive the CD-SSB, SI, and/or paging information. The idle or inactive reduced capability UE may switch to a separate BWP to perform random access, small data transfer (SDT), or to initiate a transfer to a connected mode.

The reduced capability UE may receive a configuration for an initial BWP pair including an initial RedCap downlink BWP 520 and an initial RedCap uplink BWP 530 for random access or SDT. The initial RedCap downlink BWP 520 may include resources 522 configured for a CORESET or CSS for initial access by the reduced capability UE. The initial RedCap uplink BWP 530 may include PUCCH resources and may include a random access channel occasion (e.g., an RO 532), for example. The network may assume that an idle or inactive reduced capability UE that performs random access in the separate initial BWP (e.g., transmitting a random access message in the initial RedCap uplink BWP 530 and/or monitoring for a downlink response in the initial RedCap downlink BWP 520) does not monitor for paging in the CORESET 514.

In some aspects, the separate initial BWP (e.g., the initial RedCap downlink BWP 520) for the reduced capability UEs may include a CD-SSB, and particular CORESET resources, such as CORESET #0 resources. In other aspects, the initial RedCap downlink BWP 520 for the reduced capability UEs may not include a CD-SSB (e.g., being configured without resources for a CD-SSB, not including a CD-SSB, etc., which may be referred to as an SSB-less BWP), and particular CORESET resources, such as resources for a CORESET #0, or the CORESET for the reception of SIB1, OSI, or paging information. In the illustrated example of FIG. 5, the initial RedCap downlink BWP 520 does not include a CD-SSB or a CORESET #0, for example, for random access.

In some aspects in FR1, for a separate initial DL BWP (e.g., such as the initial RedCap downlink BWP 520) that does not include the CD-SSB and the CORESET #0 (e.g., does not include an entire CORESET #0), the initial RedCap downlink BWP 520 may be configured for random access and not for paging in idle/inactive mode. The initial RedCap downlink BWP 520 may not contain SSB, CORESET #0, or SIB resources. For example, the network may assume that the reduced capability UE that is performing random access in the initial RedCap downlink BWP 520 does not monitor paging in a BWP containing the CORESET 514 (e.g., does not monitor paging in the initial downlink BWP 510). If a BWP is configured for paging, the reduced capability UE may expect the BWP to contain a non-cell-defining SSB (NCD-SSB) for the serving cell, but may not expect the BWP to include a CORESET #0/SIB. For an RRC-configured active DL BWP configured for the UE in a connected mode, and if the active DL BWP does not include the CD-SSB and the entire CORESET #0, the reduced capability UE may expect the active DL BWP to include an NCD-SSB for the serving cell, e.g., but not a CORESET #0/SIB. In some aspects, the reduced capability UE may indicate a capability in which the UE does not use an NCD-SSB. For example, the reduced capability UE may optionally support relevant operation for wireless communication based on a reference signal, such as CSI-RS, and may report the capability to the network.

If the network configures a separate initial/RRC configured DL BWP for the reduced capability UE to contain the entire CORESET #0, the reduced capability UE may expect the separate initial BWP to include a CD-SSB. The network may choose to configure an SSB or a MIB-configured CORESET #0 or SIB1 to be within the respective DL BWP. If a separate SIB-configured initial DL BWP for the reduced capability UE contains the entire CORESET #0, the reduced capability UE may use the bandwidth and location of the CORESET #0 for downlink reception during initial access. An NCD-SSB periodicity may be different than a periodicity of a CD-SSB. In some aspects, a periodicity of an NCD-SSB may not be less than a periodicity of a CD-SSB.

In some aspects in FR2, a separate initial DL BWP (e.g., the initial RedCap downlink BWP 520) that does not include a CD-SSB and the entire CORESET #0) may be configured for random access and not for paging in an idle/inactive mode. The initial RedCap downlink BWP 520 may not contain SSB, CORESET #0, or SIB resources. For example, the network may assume that the reduced capability UE that is performing random access in the initial RedCap downlink BWP 520 does not monitor paging in a BWP containing the CORESET 514 (e.g., does not monitor paging in the initial downlink BWP 510). If the initial RedCap downlink BWP is configured for paging, the reduced capability UE may expect the initial RedCap downlink BWP to contain an NCD-SSB for the serving cell, but not CORESET #0 or SIB resources.

For an RRC-configured active DL BWP configured for the UE in a connected mode, and if the active DL BWP does not include the CD-SSB and an entire CORESET #0, the reduced capability UE may expect the active DL BWP to include an NCD-SSB for the serving cell, e.g., but not a CORESET #0/SIB. In some aspects, the reduced capability UE may indicate a capability in which the UE does not use an NCD-SSB. For example, the reduced capability UE may optionally support relevant operation for wireless communication based on a reference signal, such as CSI-RS, and may report the capability to the network.

For an SSB and CORESET #0 multiplexing pattern 1, if a separate initial DL BWP is configured via RRC to contain the entire CORESET #0, the reduced capability UE may expect the separate initial DL BWP to include a CD-SSB. The network may choose to configure an SSB or a MIB-configured CORESET #0 or SIB1 to be within the respective DL BWP. If a separate SIB-configured initial DL BWP for the reduced capability UE contains the entire CORESET #0, the reduced capability UE may use the bandwidth and location of the CORESET #0 in for downlink reception during initial access. An NCD-SSB periodicity may be different than a periodicity of a CD-SSB. In some aspects, a periodicity of an NCD-SSB may not be less than a periodicity of a CD-SSB.

As described earlier, an SSB includes primary synchronization signals (PSS), secondary synchronization signals (SSS), and PBCH. The possible time locations of SSBs within a half-frame may be determined by sub-carrier spacing and the periodicity of the half-frames transmitting SSBs may be configured by the network. During a half-frame, different SSBs may be transmitted in different spatial directions, for example, using different beams and spanning the coverage area of a cell.

System information includes minimum system information and other system information. The other system information may include all SIBs not included in the minimum system information. The minimum system information includes basic information for initial access and information for acquiring any other system information. For example, minimum system information may include a master information block (MIB) and a system information block 1 (SIB1). The MIB may include cell barred status information and physical layer information of the cell to facilitate receiving further system information, for example, a CORESET #0 configuration. The SIB1 may define the scheduling of other system information blocks and may contain information for initial access. The SIB1 may also be referred to as remaining minimum system information (RMSI). The MIB may be carried on the PBCH of the SSB and provide the UE with parameters (e.g., a CORESET #0 configuration) for monitoring of PDCCH for scheduling PDSCH that carries the SIB1.

Within the frequency span of a carrier, one or more SSBs may be transmitted. The physical cell identity (PCI) of SSBs transmitted in different frequency locations may or may not be unique. For example, different SSBs in the frequency domain may have different PCIs. However, when an SSB is associated with RMSI (e.g., a SIB1), the SSB is referred to as a cell-defining SSB (CD-SSB). A primary cell (PCell) is associated to a CD-SSB located on the synchronization raster. Frequencies may be configured to be on the synchronization raster if they are also identifiable with a global synchronization channel number (GSCN).

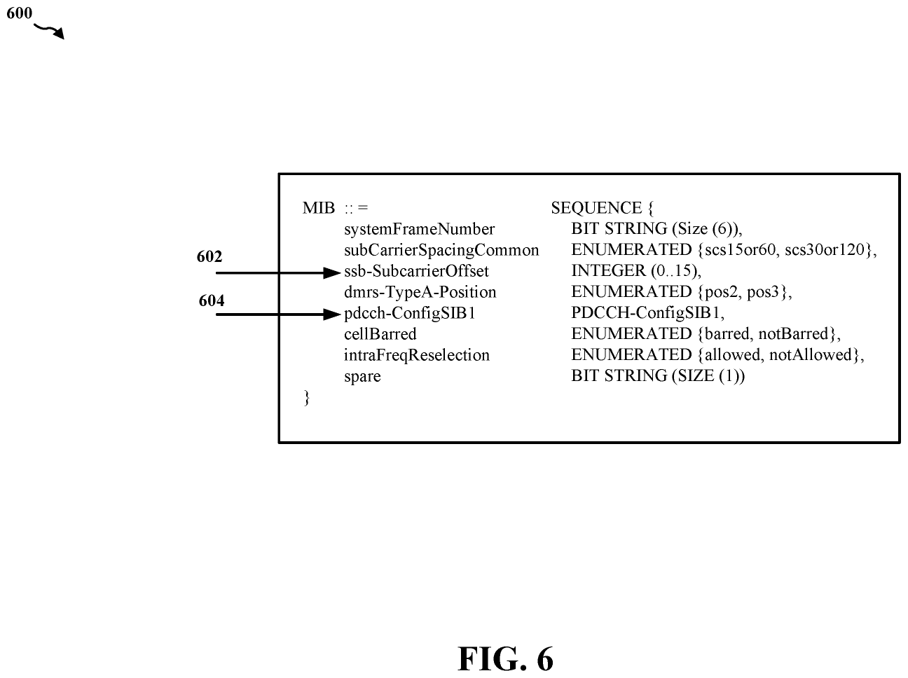

In some examples, a MIB may indicate that the SSB is not associated with RMSI (e.g., there is no associated SIB1). When an SSB is not associated with RMSI, the SSB may be referred to as a non-cell-defining SSB (NCD-SSB). While a CD-SSB is transmitted on the synchronization raster, an NCD-SSB may be transmitted on or off the synchronization raster. A UE may determine whether an SSB is a CD-SSB or an NCD-SSB based on the MIB of the SSB. FIG. 6 illustrates an example MIB message 600, as presented herein. The MIB message 600 may be transmitted from the network to a UE. The example MIB message 600 includes different fields, including an SSB subcarrier offset field 602, which may be referred to as a “ssb-SubcarrierOffset” field or by any other name. The SSB subcarrier offset field 602 corresponds to an SSB-type indicator (K_{SSB}) that signals the frequency domain offset between SSB and the overall resource block grid in number of subcarriers. For example, in FR1, the K_{SSB} may be a 5-bit value, and in FR2, the K_{SSB} may be a 4-bit value. Referring to FR1, when the value of the K_{SSB} is greater than or equal to 0 and less than 24 (e.g., 0≤K_{SSB}<24), the UE may determine that the SSB is a CD-SSB, and when the value of the K_{SSB} is greater than or equal to 24 and less than 32 (e.g., 24≤K_{SSB}<32), the UE may determine that the SSB is an NCD-SSB. With respect to FR2, when the value of the K_{SSB} is greater than or equal to 0 and less than 12 (e.g., 0≤K_{SSB}<12), the UE may determine that the SSB is a CD-SSB, and when the value of the K_{SSB} is greater than or equal to 12 and less than 16 (e.g., 12≤K_{SSB}<16), the UE may determine that the SSB is an NCD-SSB.

As shown in FIG. 6, the SSB subcarrier offset field 602 is an integer between 0 and 15 and, thus, may be represented by four bits. However, the value of the K_{SSB} for FR1 may be between 0 and 31, which corresponds to five bits. Thus, the UE may use 1-bit of the L1 portion of the PBCH payload for the fifth bit of the K_{SSB}. For example, the PBCH payload of an SSB may include 32 bits of which 24 bits are allocated to the MIB payload and 8 bits are allocated to the L1 payload.

The example MIB message 600 also includes a PDCCH SIB1 configuration field 604, which may be referred to as a “pdcch-ConfigSIB1” field or by any other name. The PDCCH SIB1 configuration field 604 may determine a common CORESET, a common search space, and PDCCH parameters. If the SSB subcarrier offset field 602 indicates that SIB1 is absent, the PDCCH SIB1 configuration field 604 may indicate the frequency positions where the UE may find an SSB with SIB1 or the frequency range where the network does not provide an SSB with SIB1. Thus, when the SSB is a CD-SSB, the PDCCH SIB1 configuration field 604 points to valid configurations for CORESET #0 and a type0 PDCCH CSS set, which may be referred to as a “Type0-PDCCH CSS set” or by another name. When the SSB is an NCD-SSB, the SSB (e.g., the PDCCH SIB1 configuration field 604) does not point to a valid configuration for CORESET #0 and the type0 PDCCH CSS set.

In some aspects, a UE may use an NCD-SSB for serving cell and non-serving cell measurements for all RRC modes (e.g., idle, inactive, and/or connected). The UE may use the measurements to facilitate with one or more of radio resource measurement (RRM), radio link monitoring (RLM), beam failure detection (BFD), link recovery, RO selection, mobility, time/frequency tracking, and automatic gain control (AGC).

In FR1 and FR2, initial and non-initial BWPs for reduced capability UEs may be configured by the network via system information and/or RRC signaling. The initial/non-initial BWPs may be configured subject to the maximum bandwidth supported by the reduced capability UEs. Depending on the functionalities of reduced capability UE-specific initial/non-initial downlink BWPs, the downlink BWPs of a reduced capability UE may have a configuration for an SSB. For example, the SSB configuration may indicate that a CD-SSB is transmitted by the serving cell, may indicate that an NCD-SSB is transmitted by the serving cell, or may indicate that no SSB is transmitted by the serving cell (e.g., that an SSB is absent).

On a cell that supports both reduced capability UEs and non-reduced capability UEs (e.g., higher capability UEs) to access, the CD-SSB and the NCD-SSB of the serving cell may provide different roles. For example, for cell selection/reselection, a UE (e.g., a reduced capability UE or a non-reduced capability UE) searches for a CD-SSB and decodes the included system information. A reduced capability UE may use either the CD-SSB or the NCD-SSB of the serving cell to perform RO selection, time/frequency tracking, link recovery, RRM measurements, RLM measurements, BFD measurements, and other tasks.

Aspects disclosed herein provide techniques for different SSB transmission in the initial/non-initial downlink BWP of different UE types (e.g., a reduced capability UE or a non-reduced capability UE) when a cell supports different UE types to access the cell. That is, when a cell supports co-existence between reduced capability UEs and non-reduced capability UEs, different SSB transmissions in the initial/non-initial downlink BWP of the different UE type may be supported. Additionally, aspects disclosed herein provide priority rules for SSB-based measurements (e.g., for RO selection, time/frequency tracking, link recovery, RRM measurements, RLM measurements, BFD measurements, and other tasks).

In some aspects, the SSB transmission in a downlink BWP of a reduced capability UE may be based on UE capability, deployment (e.g., duplex mode and/or frequency range, such as FR1 or FR2), and co-existence needs. With respect to the initial downlink BWP, the reduced capability UE may be configured with a CD-SSB being transmitted by the serving cell, an NCD-SSB being transmitted by the serving cell, or no SSB being transmitted (e.g., an SSB is absent). Additionally, with respect to the non-initial downlink BWP, the reduced capability UE may be configured with a CD-SSB being transmitted by the serving cell, an NCD-SSB being transmitted by the serving cell, or no SSB being transmitted by the serving cell.

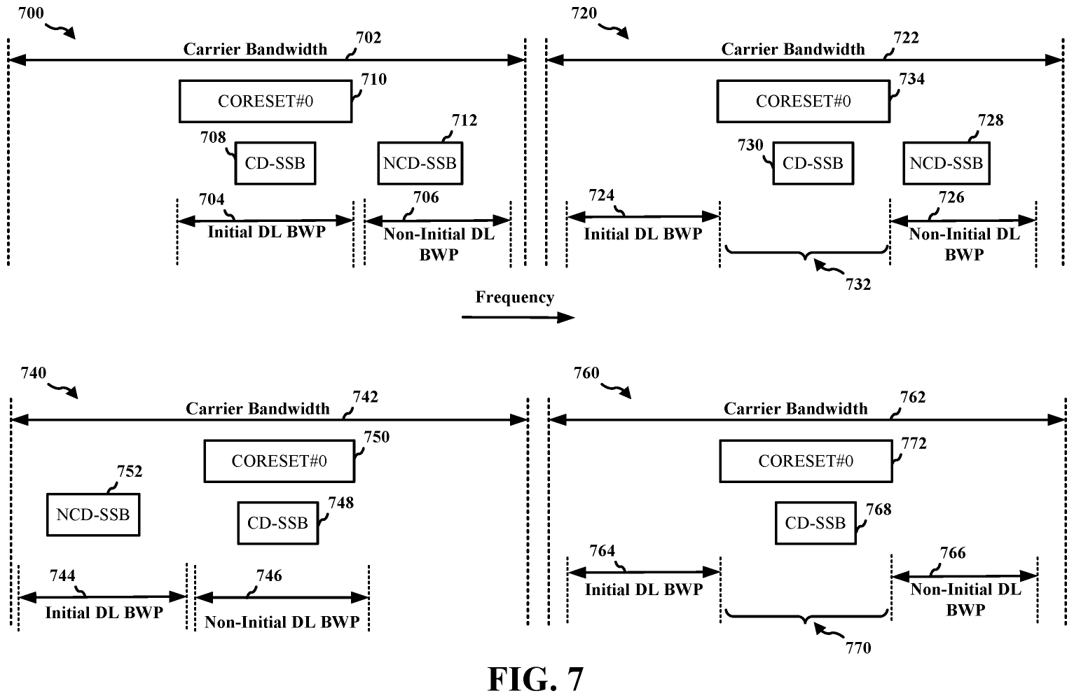

FIG. 7 illustrates example diagrams showing SSB transmissions with respect to initial downlink BWPs and non-initial downlink BWPs that may be configured within a carrier bandwidth of a serving cell for a reduced capability UE, as presented herein. In an example first diagram 700, a cell may have a carrier bandwidth 702. A reduced capability UE may be configured with an initial downlink BWP 704 and a non-initial downlink BWP 706. As shown in the first diagram 700, the reduced capability UE may receive a CD-SSB 708 within the initial downlink BWP 704. The CD-SSB 708 may also configure a CORESET #0 710 within the initial downlink BWP 704. The first diagram 700 also illustrates that the reduced capability UE may receive an NCD-SSB 712 within the non-initial downlink BWP 706.

In the illustrated example of FIG. 7, if the downlink BWP includes only a CD-SSB, a reduced capability UE is not expected to measure an NCD-SSB outside the active downlink BWP, for example, for RRM, RLM, BFD, link recovery, a tracking loop, and/or AGC. For example, in the first diagram 700, the initial downlink BWP 704 includes the CD-SSB 708 and no NCD-SSB. In such scenarios, a reduced capability UE may be configured to not measure the NCD-SSB 712 outside the initial downlink BWP 704.

In an example second diagram 720, a cell may have a carrier bandwidth 722. A reduced capability UE may be configured with an initial downlink BWP 724 and a non-initial downlink BWP 726. As shown in the second diagram 720, the reduced capability UE may receive an NCD-SSB 728 within the non-initial downlink BWP 726. The reduced capability UE may also receive a CD-SSB 730 outside the initial downlink BWP 724 and the non-initial downlink BWP 726. For example, the reduced capability UE may receive the CD-SSB 730 in a third BWP 732. The CD-SSB 730 may also configure a CORESET #0 734 within the third BWP 732.

In an example third diagram 740, a cell may have a carrier bandwidth 742. A reduced capability UE may be configured with an initial downlink BWP 744 and a non-initial downlink BWP 746. As shown in the third diagram 740, the reduced capability UE may receive a CD-SSB 748 within the non-initial downlink BWP 746. The CD-SSB 748 may also configure a CORESET #0 750 within the non-initial downlink BWP 746. The third diagram 740 also illustrates that the reduced capability UE may receive an NCD-SSB 752 within the initial downlink BWP 744.

In an example fourth diagram 760, a cell may have a carrier bandwidth 762. A reduced capability UE may be configured with an initial downlink BWP 764 and a non-initial downlink BWP 766. As shown in the fourth diagram 760, the reduced capability UE may not receive an SSB in the initial downlink BWP 764 and also may not receive an SSB in the non-initial downlink BWP 766. However, similar to the example second diagram 720, the reduced capability UE may receive a CD-SSB 768 in a third BWP 770. The CD-SSB 768 may also configure a CORESET #0 772 within the third BWP 770.

As shown in the example diagrams of FIG. 7, for a reduced capability UE, the initial downlink BWP may include a CD-SSB (e.g., as shown in the first diagram 700), may include an NCD-SSB (e.g., as shown in the third diagram 740), or may include no SSB (e.g., as shown in the second diagram 720 and the fourth diagram 760). Additionally, for the reduced capability UE, the non-initial downlink BWP may include a CD-SSB (e.g., as shown in the third diagram 740), may include an NCD-SSB (e.g., as shown in the first diagram 700 and the second diagram 720), or may include no SSB (e.g., as shown in the fourth diagram 760).

It may be appreciated that other examples may include additional or alternate combinations of a CD-SSB, an NCD-SSB, and no SSB within an initial downlink BWP and a non-initial downlink BWP for a reduced capability UE.

In some aspects, the SSB transmission in a downlink BWP of a non-reduced capability UE (e.g., a higher capability UE) may be based on the bandwidth of a SIB1-configured initial downlink BWP. With respect to the initial downlink BWP, the non-reduced capability UE may be configured with a CD-SSB being transmitted by the serving cell, or a CD-SSB and an NCD-SSB being transmitted by the serving cell. Additionally, with respect to the non-initial downlink BWP, the non-reduced capability UE may be configured with a CD-SSB being transmitted by the serving cell, an NCD-SSB being transmitted by the serving cell, a CD-SSB and an NCD-SSB being transmitted by the serving cell, or no SSB being transmitted by the serving cell. For example, the non-reduced capability UE may have the capability to operate in a bandwidth as wide as the carrier bandwidth. In such examples, the non-reduced capability UE may have the capability to receive a CD-SSB and an NCD-SSB within an initial/non-initial downlink BWP.

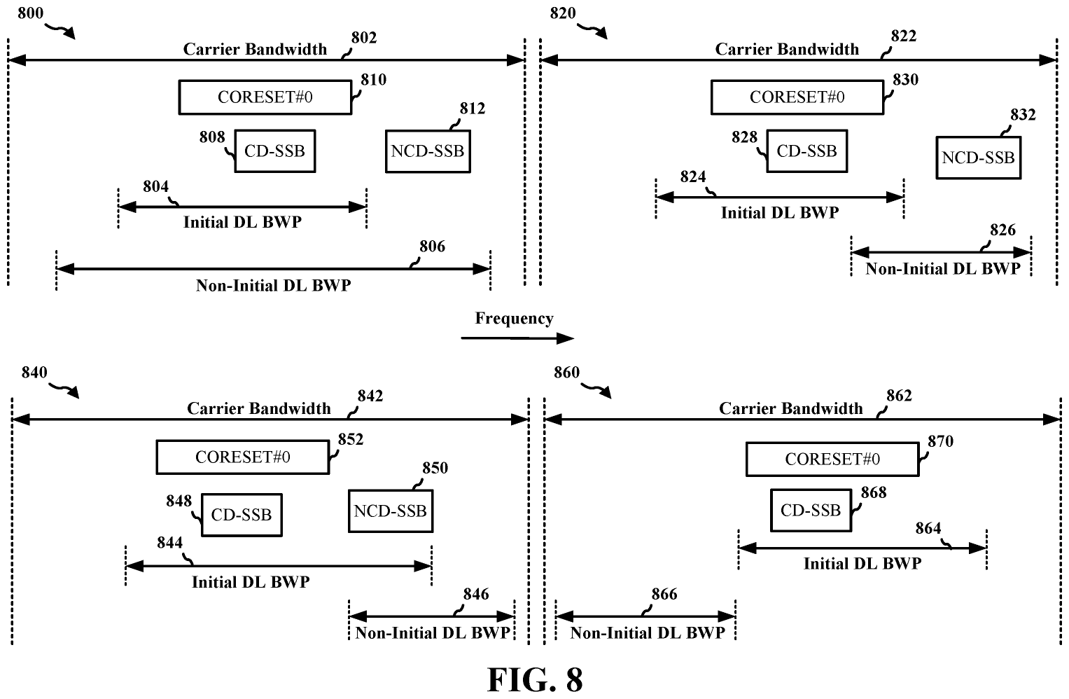

FIG. 8 illustrates example diagrams showing SSB transmissions with respect to initial downlink BWPs and non-initial downlink BWPs that may be configured within a carrier bandwidth of a serving cell for a non-reduced capability UE, as presented herein. In an example first diagram 800, a cell may have a carrier bandwidth 802. A non-reduced capability UE may be configured with an initial downlink BWP 804 and a non-initial downlink BWP 806. The initial downlink BWP 804 may be configured by SIB1 and/or by RRC signaling. In the example first diagram 800, the initial downlink BWP 804 and the non-initial downlink BWP 806 overlap in frequency resources. The non-reduced capability UE may receive a CD-SSB 808 within the initial downlink BWP 804. The CD-SSB 808 may also configure a CORESET #0 810. The first diagram 800 also illustrates that the non-reduced capability UE may receive an NCD-SSB 812 within the non-initial downlink BWP 806. In the example first diagram 800, the non-initial downlink BWP 806 overlaps with the CD-SSB 808 and the NCD-SSB 812.

In an example second diagram 820, a cell may have a carrier bandwidth 822. A non-reduced capability UE may be configured with an initial downlink BWP 824 and a non-initial downlink BWP 826. The initial downlink BWP 824 may be configured by SIB1 and/or by RRC signaling. As shown in the second diagram 820, the non-reduced capability UE may receive a CD-SSB 828 within the initial downlink BWP 824. The CD-SSB 828 may also configure a CORESET #0 830. As shown in the second diagram 820, the non-initial downlink BWP 826 may partially overlap with the initial downlink BWP 824. Additionally, the non-reduced capability UE may receive an NCD-SSB 832 within the non-initial downlink BWP 826.

In an example third diagram 840, a cell may have a carrier bandwidth 842. A non-reduced capability UE may be configured with an initial downlink BWP 844 and a non-initial downlink BWP 846. The initial downlink BWP 844 may be configured by SIB1 and/or by RRC signaling. As shown in the third diagram 840, the non-reduced capability UE may receive a CD-SSB 848 and an NCD-SSB 850 within the initial downlink BWP 844. The CD-SSB 848 may also configure a CORESET #0 852 within the initial downlink BWP 844. The third diagram 840 also illustrates that the NCD-SSB 850 may overlap with the non-initial downlink BWP 846.

In an example fourth diagram 860, a cell may have a carrier bandwidth 862. A non-reduced capability UE may be configured with an initial downlink BWP 864 and a non-initial downlink BWP 866. The initial downlink BWP 864 may be configured by SIB1 and/or by RRC signaling. As shown in the fourth diagram 860, the non-reduced capability UE may receive a CD-SSB 868 within the initial downlink BWP 864. The CD-SSB 868 may also configure a CORESET #0 870 within the initial downlink BWP 864. In the example fourth diagram 860, the initial downlink BWP 864 and the non-initial downlink BWP 866 are non-overlapping. Additionally, the non-reduced capability UE may not receive an SSB within the non-initial downlink BWP 866.

As shown in the example diagrams of FIG. 8, for a non-reduced capability UE, the initial downlink BWP includes at least the CD-SSB. The initial downlink BWP may also include the NCD-SSB (e.g., as shown in the example third diagram 840). Additionally, for the non-reduced capability UE, the non-initial downlink BWP may include a CD-SSB (e.g., as shown in the first diagram 800), may include an NCD-SSB (e.g., as shown in the first diagram 800, the second diagram 820, and the third diagram 840), may include the CD-SSB and the NCD-SSB (e.g., as shown in the first diagram 800), or may include no SSB (e.g., as shown in the fourth diagram 860).

It may be appreciated that other examples may include additional or alternate combinations of a CD-SSB, an NCD-SSB, a CD-SSB and an NCD-SSB, and no SSB within an initial downlink BWP and a non-initial downlink BWP for a non-reduced capability UE.

In some aspects, CD-SSBs and NCD-SSBs transmitted by a same cell may share the same PSS/SSS sequences and PCI. The CD-SSBs and the NCD-SSBs may also include the same number/pattern of SS blocks, which may be indicated by an SSB position in burst field (e.g., which may be referred to as an “ssb-PositionInBurst” field or by another name) of SIB1 or may be indicated by a serving cell configuration common information element, which may be referred to as a “ServingCellConfigCommon” information element or by another name, of RRC signaling. The CD-SSB and the NCD-SSB may also have the same transmit power and the energy per resource element (EPRE) boosting ratio, at least for the purposes of RRM measurements and/or RLM measurements.

Within the channel bandwidth of a serving cell, the CD-SSB bursts and the NCD-SSB bursts may have the same periodicities or different periodicities. Additionally, a serving cell may use multiplexing when transmitting CD-SSB and NCD-SSB. For example, the CD-SSB bursts and the NCD-SSB bursts may be multiplexed in the time/frequency domain by time division multiplexing (TDM), frequency division multiplexing (FDM), or a hybrid of TDM and FDM.

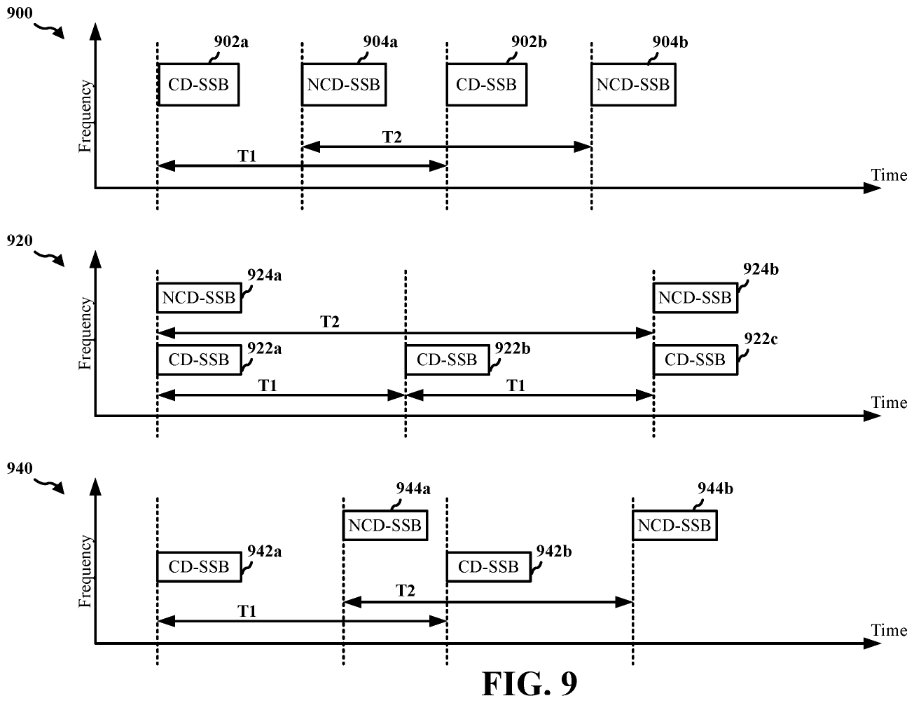

FIG. 9 illustrates example diagrams showing multiplexing in time/frequency domain of CD-SSB bursts and NCD-SSB bursts, as presented herein. In the example diagrams, the CD-SSB bursts have a first periodicity (T1) and the NCD-SSB bursts have a second periodicity (T2). In some examples, the first periodicity and the second periodicity may be the same. In other examples, the first periodicity and the second periodicity may be different.

In the example of FIG. 9, a first diagram 900 illustrates CD-SSB bursts and NCD-SSB bursts being multiplexed by TDM. For example, a CD-SSB burst may include a first CD-SSB 902a and a second CD-SSB 902b having a first periodicity (T1). An NCD-SSB burst may include a first NCD-SSB 904a and a second NCD-SSB 904b having a second periodicity (T2). In the example first diagram 900, the SSBs of the respective CD-SSB burst and the NCD-SSB burst are transmitted in a same frequency range but at non-overlapping times and, thus, the CD-SSB burst and the NCD-SSB burst are multiplexed by TDM.

A second diagram 920 illustrates CD-SSB bursts and NCD-SSB busts being multiplexed by FDM. For example, a CD-SSB burst may include a first CD-SSB 922a, a second CD-SSB 922b, and a third CD-SSB 922c having a first periodicity (T1). An NCD-SSB burst may include a first NCD-SSB 924a and a second NCD-SSB 924b having a second periodicity (T2). In the example second diagram 920, the SSBs of the respective CD-SSB burst and the NCD-SSB burst are transmitted in non-overlapping frequency ranges, but may overlap in time. For example, the first CD-SSB 922a and the first NCD-SSB 924a overlap in time and the third CD-SSB 922c and the second NCD-SSB 924b overlap in time and, thus, the CD-SSB burst and the NCD-SSB burst are multiplexed by FDM.

A third diagram 940 illustrates CD-SSB bursts and NCD-SSB busts being multiplexed by a hybrid of TDM and FDM. For example, a CD-SSB burst may include a first CD-SSB 942a and a second CD-SSB 942b having a first periodicity (T1). An NCD-SSB burst may include a first NCD-SSB 944a and a second NCD-SSB 944b having a second periodicity (T2). In the example third diagram 940, the SSBs of the respective CD-SSB burst and the NCD-SSB burst are transmitted in non-overlapping frequency ranges (e.g., FDM) and at non-overlapping times (e.g., TDM) and, thus, the CD-SSB burst and the NCD-SSB burst are multiplexed by a hybrid of TDM and FDM.

In some aspects, a UE may receive a configuration for a downlink BWP based on a capability of the UE (e.g., a UE capability). A UE capability may refer to a UE class or type, such as a reduced capability UE or a higher capability UE. In some aspects, the UE capability may additionally, or alternatively, indicate one or more specific granular capabilities of the UE, such as whether the UE supports a particular duplex mode type, one or more supported frequency ranges, etc. Additionally, or alternatively, the UE may receive a configuration for a downlink BWP based on a type of the downlink BWP. In some examples, the configuration may indicate that the downlink BWP includes both the CD-SSB and the NCD-SSB from a serving cell. In some such examples, the UE may not be expected to measure both CD-SSB bursts and NCD-SSB bursts within the same slot. For example, the UE may measure one of the CD-SSB or the NCD-SSB in a slot and skip a measurement of the other of the CD-SSB or the NCD-SSB in the slot.

In some examples, the UE may operate in TDD or HD-FDD and there may be a collision between SSB reception and uplink transmission at the UE. A collision may include an SSB overlapping with an uplink transmission in the time domain. In some examples, a collision may include an SSB and an uplink transmission non-overlapping in the time domain, but a DL/UL switching gap at the UE for SSB reception and UL transmission may be insufficient. For example, the UE may not have sufficient time to switch between a receiving mode to receive the SSB and a transmitting mode to transmit the uplink transmission. In such examples in which a collision may occur, the UE may prioritize SSB measurement defined by a configuration over a dynamically scheduled uplink transmission (e.g., determined via DCI) or an uplink transmission configured by higher layers (e.g., determined via a MAC-CE and/or by RRC signaling). For SSB bursts not defined by the configuration, the UE may prioritize the uplink transmission instead. For example, for intra-frequency and inter-frequency measurements, a configuration of a measurement object may indicate the frequency and/or time resources and subcarrier spacing of reference signals to be measurements. The reference signals may include CD-SSB, NCD-SSB, or CSI-RS provided by serving cells and/or neighboring cells. A UE may be configured with multiple reference signals for measurement. Although a configuration for a measurement object may indicate or define a reference signal, the configuration may not indicate and/or may not define all reference signals configured for the UE. Thus, in some examples, the configuration for the measurement may define an SSB burst including CD-SSBs and/or NCD-SSBs. In other examples, the configuration for the measurement object may not define or indicate an SSB burst.

For example, the measurement object of the UE may be defined by system information and/or RRC signaling. The measurement object may include CD-SSB bursts, NCD-SSB bursts, or a combination of CD-SSB bursts and NCD-SSB bursts distributed across different slots. The periodicity, number, and/or type of the SSB (e.g., CD-SSB, NCD-SSB, or a hybrid) bursts to be measured by the UE may be configured by the network in the configuration.

For example, the UE may be operating in a TDD mode or an HD-FDD mode and receive scheduling for an uplink transmission. Based on a determination that SSB reception and the uplink transmission may collide (e.g., an overlap in the time domain or based on the switching gap associated with the uplink transmission), the UE may either prioritize measuring the SSB or transmitting the uplink transmission. For example, the UE may measure an SSB that is defined by a configuration and skip transmission of the uplink transmission based on the collision. In other examples, the UE may skip measurement of an SSB that is not defined by a configuration configured for the UE and may transmit the uplink transmission based on the collision.

In some examples, the configuration may indicate that the downlink BWP includes only the CD-SSB transmitted by the serving cell. In some such examples, the configuration may indicate that the downlink BWP does not include NCD-SSB transmitted by the serving cell or the configuration of the NCD-SSB may not be signaled to the UE. In examples in which the configuration indicates that the downlink BWP includes only the CD-SSB transmitted by the serving cell, the UE may not be expected to measure the NCD-SSB outside the active downlink BWP, the measurement being for one or more of cell selection/reselection, RRM, RLM, BFD, link recovery, a tracking loop, or AGC.

In some examples, the configuration may indicate that the downlink BWP includes no SSB or the configuration for the SSB may not be signaled to the UE. In examples in which the configuration does not indicate the SSB from a serving cell, the UE may switch to a different BWP to measure the CD-SSB from the serving cell if the UE is in an RRC idle state or in an RRC inactive state. If the UE is in an RRC connected state, the UE may switch to the different BWP to measure the CD-SSB and/or the NCD-SSB from the serving cell.

In some examples, there may be a BWP switch delay associated with the priority handling of the UE. For example, when the UE operates in a TDD mode or an HD-FDD mode, the BWP switch delay in the RRC idle state, the RRC inactive state, or the RRC connected state may be included in a time gap consideration for collision handling between SSB measurement and uplink transmission.

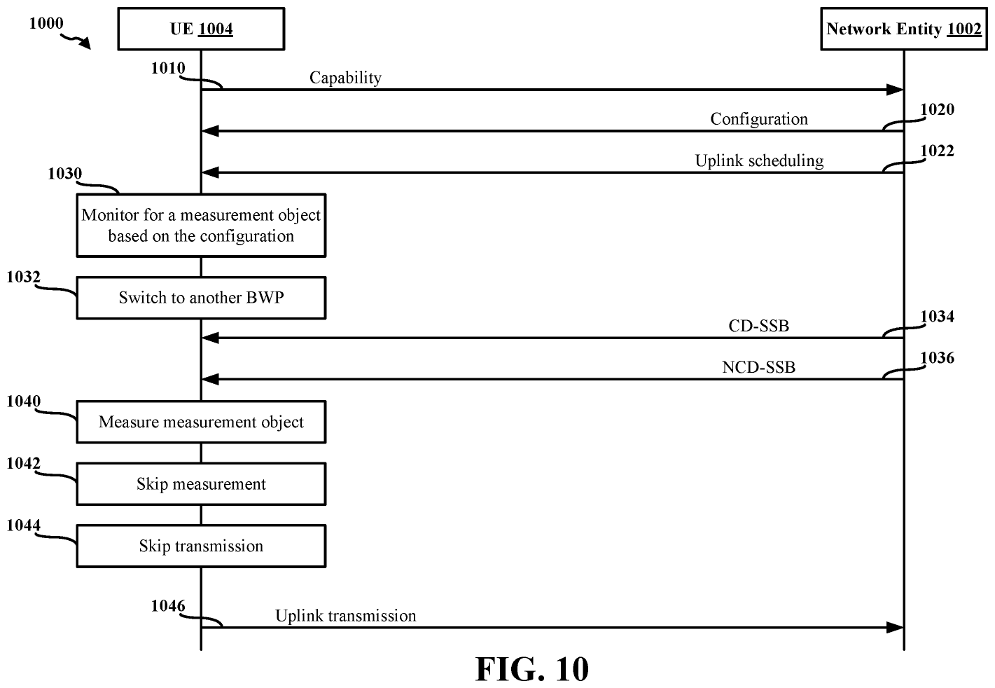

FIG. 10 illustrates an example communication flow 1000 between a network entity 1002 and a UE 1004, as presented herein. One or more aspects described for the network entity 1002 may be performed by a component of a base station or a network entity, such as a CU, a DU, and/or an RU. In the illustrated example, the communication flow 1000 facilitates techniques for different SSB transmission in the initial/non-initial downlink BWP of different UE types.

Aspects of the network entity 1002 may be implemented by the base station 102 of FIG. 1 and/or the base station 310 of FIG. 3. Aspects of the UE 1004 may be implemented by the UE 104 of FIG. 1 and/or the UE 350 of FIG. 3. Although not shown in the illustrated example of FIG. 10, it may be appreciated that in additional or alternative examples, the network entity 1002 and/or the UE 1004 may be in communication with one or more other base stations or UEs.

In the illustrated example of FIG. 10, the UE 1004 transmits a capability 1010 that is obtained (e.g., received) by the network entity 1002. The capability 1010 may indicate whether the network entity 1002 is a reduced capability UE or a non-reduced capability UE (e.g., a higher capability UE). The UE 1004 may transmit the capability 1010 via DCI, a MAC control element (MAC-CE), and/or RRC signaling. For example, the UE 1004 may transmit the capability 1010 via a UE capability information message, which may be referred to as a “UECapabilityInformation” message, or by any other name.

The network entity 1002 may configure serving cell measurements for one or more downlink BWPs. For example, the network entity 1002 may output (e.g., transmit) a configuration 1020 that is received by the UE 1004. The network entity 1002 may output the configuration 1020 via system information and/or RRC signaling. The configuration may indicate that a downlink BWP configured for the 1004/includes a CD-SSB, includes an NCD-SSB, or that the downlink BWP does not include an SSB (e.g., an SSB is absent in the downlink BWP). In some examples, the configuration 1020 may be based on a duplex mode type, a frequency range (e.g., FR1 or FR2), a type of the downlink BWP (e.g., an initial downlink BWP or a non-initial downlink BWP), and/or a UE capability of the UE 1004 (e.g., a reduced capability UE or a non-reduced capability UE) indicated by the capability 1010. For example, if a serving cell supports paired spectrum (e.g., an FDD mode), the configuration 1020 may configure the UE 1004 to switch the downlink BWP (e.g., for intra-frequency or inter-frequency measurements of an SSB) without switching its uplink BWP. In examples, in which the UE 1004 has the capability to support the FD-FDD mode, the configuration 1020 may configure the UE 1004 to measure SSB on downlink without interrupting its uplink transmission. In examples, in which the serving cell supports unpaired spectrum (e.g., a TDD mode), or the UE 1004 has the capability to support the HD-FDD mode (e.g., and not the FD-FDD mode), the configuration 1020 may configure the UE 1004 so that simultaneous downlink measurement and uplink transmission is not scheduled.

In the illustrated example of FIG. 10, the UE 1004 may perform a monitoring procedure 1030 to monitor a measurement object based on the configuration 1020. For example, the UE 1004 may monitor an initial downlink BWP or a non-initial downlink BWP. The UE 1004 may monitor for a CD-SSB and/or an NCD-SSB in a downlink BWP, or may know that the downlink BWP does not include an SSB.

As shown in FIG. 10, the network entity 1002 may output a CD-SSB 1034 that is received by the UE 1004. Additionally, or alternatively, the network entity 1002 may output an NCD-SSB 1036 that is received by the UE 1004. The network entity 1002 may output the CD-SSB 1034 and/or the NCD-SSB 1036 in an initial downlink BWP and/or a non-initial downlink BWP.

In some examples, the UE 1004 may perform a measurement procedure 1040 to measure a measurement object based on the configuration 1020 for a downlink BWP. For example, the UE 1004 may measure SSBs received in a slot.

In some examples, the UE 1004 may perform an abstaining procedure 1042 to skip performing measurements on measurement objects based on the configuration 1020 for a downlink BWP. In some examples, the UE 1004 may perform the abstaining procedure 1042 when the configuration 1020 indicates that the downlink BWP does not include any SSBs.

In some examples, the UE 1004 may perform the measurement procedure 1040 to measure a first subset of SSBs received in a downlink BWP and may also perform the abstaining procedure 1042 to skip performing measurements on a second subset of SSBs in the downlink BWP.

In some examples, UE 1004 may be configured so that collision occasions may occur between receiving an SSB and transmitting an uplink transmission. For example, the network entity 1002 may output uplink scheduling information 1022 that is received by the UE 1004. The uplink scheduling information 1022 may include semi-static or dynamic scheduling information for an uplink transmission 1046.

In some examples, the UE 1004 may determine, based on the uplink scheduling information 1022 and the configuration 1020 that a collision may occur between an SSB and the uplink transmission 1046. In some such examples, the UE 1004 may determine to perform the measurement procedure 1040 to measure the received SSB (e.g., the CD-SSB 1034 and/or the NCD-SSB 1036) and may perform a skipping procedure 1044 to skip transmitting the uplink transmission 1046. In other examples, the UE 1004 may determine, based on the occurrence of the collision occasion, to perform the abstaining procedure 1042 to skip performing the measurement on the received SSB and to transmit the uplink transmission 1046.

In some examples, the UE 1004 may determine, based on the configuration 1020, that a downlink BWP does not include an SSB. In some such examples, the UE 1004 may perform a switching procedure 1032 to switch to a different BWP. The UE 1004 may then perform the measurement procedure 1040 to measure an SSB in the different BWP. In some examples, if the UE 1004 is in an RRC idle state, the UE 1004 may perform the switching procedure 1032 to measure the CD-SSB 1034 in the different BWP. In other examples, if the UE 1004 is in an RRC connected state or an RRC inactive state, the UE 1004 may perform the switching procedure 1032 to measure the CD-SSB 1034 or the NCD-SSB 1036 in the different BWP. In some examples, a BWP switch delay associated with switching to the different BWP to measure the CD-SSB 1034 or the NCD-SSB 1036 may be included in a time gap consideration with respect to collision occasions.

In some examples, the uplink transmission 1046 may include a PUSCH, a PUCCH, or an SRS. In some examples, the UE 1004 may fully skip transmission or partially skip transmission of the uplink transmission 1046 based in part on a switching gap. The switching gap may be determined based on a minimum time from reception to transmission (N_{Rx-Tx}) or a minimum time from transmission to reception (N_{Tx-Rx}).

The UE 1004 may fully skip the transmission (e.g., via the skipping procedure 1044) by not transmitting the PUSCH or the PUCCH. For example, the UE 1004 may skip transmitting PUSCH or PUCCH if a last symbol of the PUSCH transmission or PUCCH transmission overlaps with the switching gap prior to a first symbol of the next earliest SSB. The UE 1004 may additionally, or alternatively, skip transmitting PUSCH or PUCCH if a first symbol of the PUSCH transmission or PUCCH transmission overlaps with the switching gap after a last symbol of the previous latest SSB.

The UE 1004 may partially skip the transmission (e.g., the via the skipping procedure 1044) by not transmitting SRS. For example, the UE 1004 may not transmit SRS in symbols that overlap with the switching gap prior to a first symbol of the next earliest SSB. The UE 1004 may additionally, or alternatively, skip transmitting SRS in symbols that overlap with the switching gap after a last symbol of the previous latest SSB.

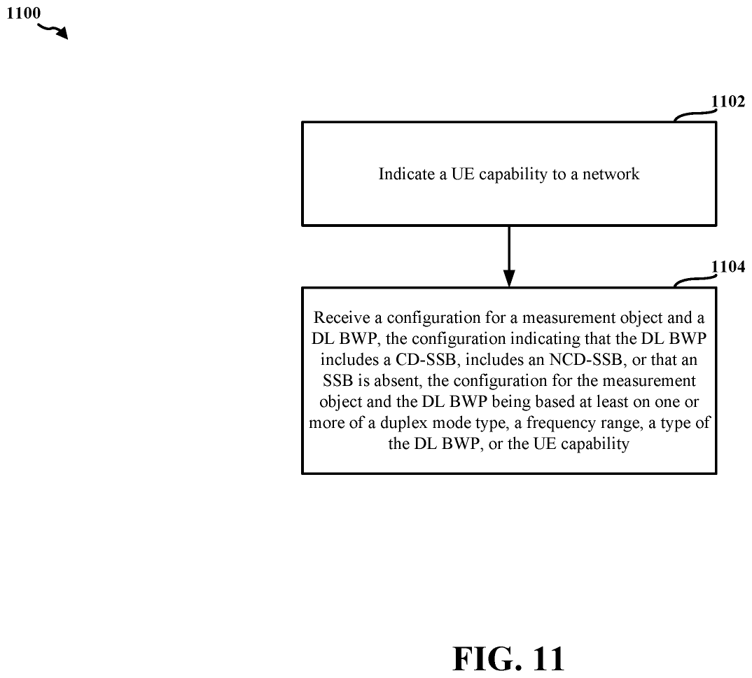

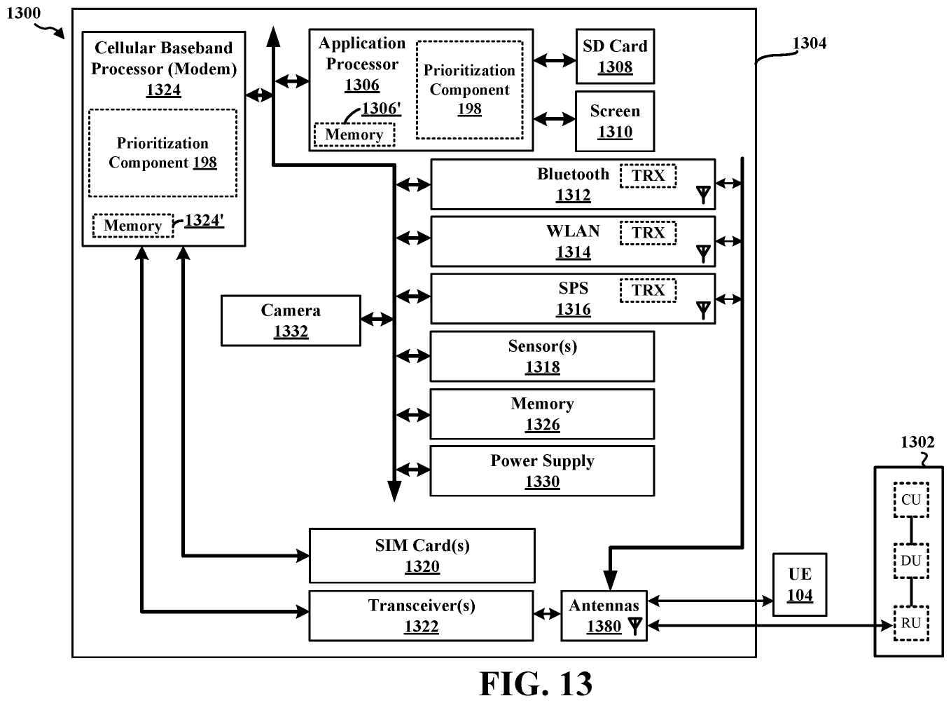

FIG. 11 is a flowchart 1100 of a method of wireless communication. The method may be performed by a UE (e.g., the UE 104, and/or an apparatus 1304 of FIG. 13). The method may facilitate improving synchronization and measurements for reduced capability UEs.

At 1102, the UE indicates a UE capability to a network, as described in connection with the capability 1010 of FIG. 10. For example, the UE may be a reduced capability or a higher capability UE. The indicating of the capability, at 1102, may be performed by a cellular RF transceiver 1322/the prioritization component 198 of the apparatus 1304 of FIG. 13.

At 1104, the UE receives a configuration for a measurement object and a downlink BWP in system information or an RRC message, as described in connection with the configuration 1020 of FIG. 10. The configuration may indicate that the downlink BWP includes a CD-SSB, includes an NCD-SSB, or that an SSB is absent. The configuration for the measurement object and the downlink BWP may be based at least on one or more of a duplex mode type, a frequency range, a type of the downlink BWP, or the UE capability. The receiving of the configuration, at 1104, may be performed by the cellular RF transceiver 1322/the prioritization component 198 of the apparatus 1304 of FIG. 13.

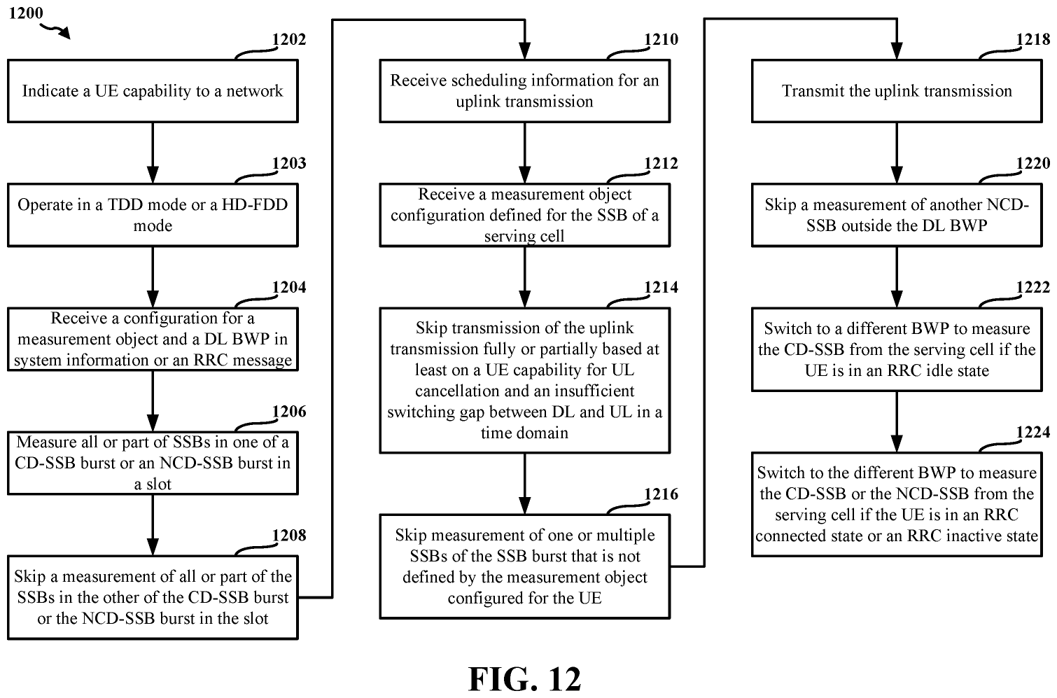

FIG. 12 is a flowchart 1200 of a method of wireless communication. The method may be performed by a UE (e.g., the UE 104, and/or an apparatus 1304 of FIG. 13). The method may facilitate improving synchronization and measurements for reduced capability UEs.

At 1202, the UE indicates a UE capability to a network, as described in connection with the capability 1010 of FIG. 10. For example, the UE may be a reduced capability or a higher capability UE. The indicating of the capability, at 1202, may be performed by a cellular RF transceiver 1322/the prioritization component 198 of the apparatus 1304 of FIG. 13.

At 1204, the UE receives a configuration for a measurement object and a downlink BWP in system information or an RRC message, as described in connection with the configuration 1020 of FIG. 10. The configuration may indicate that the downlink BWP includes a CD-SSB, includes an NCD-SSB, or that an SSB is absent. The configuration for the measurement object and the downlink BWP may be based at least on one or more of a duplex mode type, a frequency range, a type of the downlink BWP, or the UE capability. For example, the UE configuration may be different based on the UE being a reduced capability UE or a higher capability UE and/or may be different if the DL BWP is an initial DL BWP or a non-initial BWP. As an example, the configuration may be for a duplex mode including TDD, HD-FDD, or FD-FDD. If the UE supports FD-FDD, the UE may support simultaneous SSB measurement and UL transmission without collision handling. As an example, the frequency range may be FR1, FR2, a licensed spectrum or an unlicensed spectrum. The receiving of the configuration, at 1204, may be performed by the cellular RF transceiver 1322/the prioritization component 198 of the apparatus 1304 of FIG. 13.

In some aspects, the UE may have a reduced capability and the configuration, at 1204, may be for an initial DL BWP that includes one of the CD-SSB or the NCD-SSB or the configuration may be for the initial DL BWP that does not include the SSB of the serving cell, as described in connection with the examples of FIG. 7. In some aspects, the UE may have a reduced capability and the configuration may be for a non-initial DL BWP that includes one of the CD-SSB or the NCD-SSB or the configuration may be for the non-initial DL BWP that does not include the SSB of the serving cell, as described in connection with the examples of FIG. 7.

In some aspects, the UE may be a higher capability UE and the configuration may be for an initial DL BWP that includes the CD-SSB or that includes the CD-SSB and the NCD-SSB of the serving cell, as described in connection with the examples of FIG. 8. In some aspects, the UE may be a higher capability UE and the configuration may be for a non-initial DL BWP for the UE in an RRC connected state and includes at least one of the CD-SSB or the NCD-SSB or the configuration may be for the non-initial DL BWP that does not include the SSB of the serving cell, as described in connection with the examples of FIG. 8.

In some aspects, the configuration (e.g., at 1204) may be for the DL BWP that includes the CD-SSB and the NCD-SSB from a serving cell, the CD-SSB and the NCD-SSB sharing at least one of: a same primary synchronization signal sequence, a same secondary synchronization signal sequence, a PCI, a same number of SSBs transmitted in each SSB burst, a same pattern of SSBs transmitted in each SSB burst, a same transmission power, a same periodicity of an SSB burst, a same QCL resource, a same numerology for one or multiple physical signals or physical channels of the SSBs, or a same EPRE boosting ratio for the one or multiple physical signals or physical channels of the SSBs.

In some examples, CD-SSB bursts may be multiplexed in at least one of time or frequency with NCD-SSB bursts in the DL BWP, as described in connection with the examples of FIG. 9. For example, SSB includes PSS, SSS and PBCH (which may include DMRS), e.g., as described in connection with FIG. 2C. In some aspects, a same numerology (e.g., subcarrier spacing and cyclic prefix) can be applied to all or a subset of the physical signals (PSS, SSS, DMRS of PBCH) and the physical channels (PBCH data REs without DMRS). In some aspects, EPRE boosting can be applied to all or a subset of the physical signals (PSS, SSS, DMRS of PBCH) and the physical channels (PBCH data REs without DMRS).

In some aspects, the configuration may be for the DL BWP including both the CD-SSB and the NCD-SSB from a serving cell, and the measurement object of the serving cell. In some such examples, the UE may, at 1206, measure all or part of SSBs in one of the CD-SSB bursts or the NCD-SSB bursts in a slot, as described in connection with the measurement procedure 1040 of FIG. 10. The UE may also skip, at 1208, a measurement of all or part of the SSBs in the other of the CD-SSB burst or the NCD-SSB burst in the slot, as described in connection with the abstaining procedure 1042 of FIG. 10. In some aspects, one SSB burst may include multiple SSBs, which may span multiple slots. For example, an SSB burst in FR1 may include up to eight SSBs or up to 64 for higher frequencies. Depending on the configuration of the measurement object, UE may selectively measure a subset of the SSBs transmitted in a SSB burst. The performing of 1206 and 1208 may be performed by the prioritization component 198 of the apparatus 1304 of FIG. 13.

In some aspects, the UE may operate, at 1203, in a TDD mode or a HD-FDD mode. The UE may receive, at 1210, scheduling (e.g., semi-static or dynamic scheduling information) for an uplink transmission, as described in connection with the uplink scheduling information 1022 of FIG. 10. As an example, semi-static UL scheduling may include the cell-specific configuration by SI, or a UE-specific configuration by a dedicated RRC or MAC-CE. Dynamic UL scheduling may include a dynamic UL grant in PDCCH or PDSCH (e.g. random access response for msg3). The uplink transmission may overlap in time, or a switching gap may overlap in time, with measurement of an SSB. The UE may receive, at 1212, a measurement object configuration defined for the SSB of the serving cell, where the SSBs have an insufficient switching gap associated with the scheduled uplink transmission. An insufficient switching gap may correspond to one or more of SSBs that overlap with the UL transmission or the SSBs do not overlap with UL transmission. The UE may measure, at 1206, a measurement object defined SSB, the SSB having an overlap in a time domain with one or more of the uplink transmission or a switching gap associated with the uplink transmission. The UE may skip, at 1214, transmission of the uplink transmission fully or partially based at least on the UE capability for UL cancellation (e.g., whether the UE can cancel the UL transmission partially or fully may be an optional UE capability) and the switching gap between DL and UL in the time domain, as described in connection with the skipping procedure 1044 of FIG. 10. Aspects of 1203, 1206, 1212, and 1214 may be performed by the prioritization component 198 of the apparatus 1304 of FIG. 13.

In some aspects, the UE may operate, at 1203, in a TDD mode or a HD-FDD mode. The UE may receive, at 1210, scheduling (e.g., semi-static or dynamic scheduling information) for an uplink transmission that overlaps with SSBs of an SSB burst that is not defined by a measurement configuration for the UE, as described in connection with the uplink scheduling information 1022 of FIG. 10. The UE may skip, at 1216, measurement of one or multiple SSBs of an SSB burst that is not defined by a configuration configured for the UE, as described in connection with the abstaining procedure 1042 of FIG. 10. The UE may transmit, at 1218, the uplink transmission that overlaps in time with the SSB, as described in connection with the uplink transmission 1046 of FIG. 10. Aspects of 1203, 1210, 1216, and 1218 may be performed by the prioritization component 198 of the apparatus 1304 of FIG. 13.

In some aspects, the configuration, at 1204, may be for the DL BWP that includes the CD-SSB and does not include the NCD-SSB from a serving cell, as described in connection with the initial downlink BWP 704 and the non-initial downlink BWP 746 of FIG. 7, and/or the initial downlink BWP 804, the initial downlink BWP 824, and the initial downlink BWP 864 of FIG. 8. The UE may skip, at 1220, a measurement of the other of the NCD-SSB, as described in connection with the abstaining procedure 1042 of FIG. 10. The measurement may be for one or more of cell selection, cell reselection, radio resource management, radio link monitoring, beam management, UL resource selection, power control, timing advance validation, link recovery, a tracking loop, or automatic gain control. Aspects of 1220 may be performed by the prioritization component 198 of the apparatus 1304 of FIG. 13.

In some aspects, the configuration, at 1204, may be for the DL BWP that does not include the SSB from a serving cell, as described in connection with the initial downlink BWP 724, the initial downlink BWP 764, and the non-initial downlink BWP 766 of FIG. 7, and/or the non-initial downlink BWP 866 of FIG. 8. The UE may switch, at 1222, to a different BWP to measure the CD-SSB from the serving cell if the UE is in an RRC idle state, and the UE may switch, at 1224, to the different BWP to measure the CD-SSB or the NCD-SSB from the serving cell if the UE is in an RRC connected state or an RRC inactive state, as described in connection with the switching procedure 1032 of FIG. 10. Aspects of 1222 and 1224 may be performed by the prioritization component 198 of the apparatus 1304 of FIG. 13.

In some aspects, the UE may operate, at 1203, in a TDD mode or a HD-FDD mode, and a BWP switch delay associated with switching to the different BWP to measure the CD-SSB or the NCD-SSB may be included in a time gap consideration for at least measurement object configuration and collision handling between SSB measurement and uplink transmission. Aspects of 1203 may be performed by the prioritization component 198 of the apparatus 1304 of FIG. 13.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers (e.g., a cellular RF transceiver 1322). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize one or more antennas 1380 for communication. The cellular baseband processor 1324 communicates through transceiver(s) (e.g., the cellular RF transceiver 1322) via one or more antennas 1380 with the UE 104 and/or with an RU associated with a network entity 1302. The cellular baseband processor 1324 and the application processor 1306 may each include a computer-readable medium/memory, such as the on-chip memory 1324′, and the on-chip memory 1306′, respectively. The additional memory modules 1326 may also be considered a computer-readable medium/memory. Each computer-readable medium/memory (e.g., the on-chip memory 1324′, the on-chip memory 1306′, and/or the additional memory modules 1326) may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see the UE 350 of FIG. 3) and include the additional modules of the apparatus 1304.

As discussed supra, the prioritization component 198 is configured to indicate a UE capability to a network; and receive a configuration for a measurement object and a DL BWP in system information or a RRC message, the configuration indicating that the DL BWP includes a CD-SSB, includes a NCD-SSB, or that an SSB is absent, the configuration for the measurement object and the DL BWP being based at least on one or more of a duplex mode type, a frequency range, a type of the DL BWP, or the UE capability.

The prioritization component 198 may be within the cellular baseband processor 1324, the application processor 1306, or both the cellular baseband processor 1324 and the application processor 1306. The prioritization component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1304 may include a variety of components configured for various functions. For example, the prioritization component 198 may include one or more hardware components that perform each of the blocks of the algorithm in the flowcharts of FIG. 11 and/or FIG. 12.

In one configuration, the apparatus 1304, and in particular the cellular baseband processor 1324 and/or the application processor 1306, includes means for indicating a UE capability to a network. The example apparatus 1304 also includes means for receiving a configuration for a measurement object and a DL BWP in system information or a RRC message, the configuration indicating that the DL BWP includes a CD-SSB, includes a NCD-SSB, or that an SSB is absent, the configuration for the measurement object and the DL BWP being based at least on one or more of a duplex mode type, a frequency range, a type of the DL BWP, or the UE capability.

In another configuration, the example apparatus 1304 also includes means for measuring all or part of SSBs in one of a CD-SSB burst or an NCD-SSB burst in a slot. The example apparatus 1304 also includes means for skipping a measurement of all or part of the SSBs in a different one of the CD-SSB burst or the NCD-SSB burst in the slot.

In another configuration, the example apparatus 1304 also includes means for operating in a TDD mode or a HD-FDD mode. The example apparatus 1304 also includes means for receiving semi-static or dynamic scheduling information for an uplink transmission. The example apparatus 1304 also includes means for receiving a measurement object configuration defined for the SSB of the serving cell, where SSBs have an insufficient switching gap associated with the uplink transmission. The example apparatus 1304 also includes means for skipping transmission of the uplink transmission fully or partially based at least on a UE capability for UL cancellation and the insufficient switching gap between DL and UL in a time domain.

In another configuration, the example apparatus 1304 also includes means for operating in a TDD mode or a HD-FDD mode. The example apparatus 1304 also includes means for receiving semi-static or dynamic scheduling information for an uplink transmission, which overlaps with SSBs of a SSB burst that is not defined by a measurement configuration for the UE. The example apparatus 1304 also includes means for skipping measurement of one or multiple SSBs of the SSB burst that is not defined by the configuration configured for the UE. The example apparatus 1304 also includes means for transmitting the uplink transmission.

In another configuration, the example apparatus 1304 also includes means for skipping a measurement of another NCD-SSB outside the DL BWP, the measurement being for one or more of cell selection, cell reselection, radio resource management, radio link monitoring, beam management, UL resource selection, power control, timing advance validation, link recovery, a tracking loop, or automatic gain control.

In another configuration, the example apparatus 1304 also includes means for switching to a different BWP to measure the CD-SSB from the serving cell if the UE is in an RRC idle state. The example apparatus 1304 also includes means for switching to the different BWP to measure the CD-SSB or the NCD-SSB from the serving cell if the UE is in an RRC connected state or an RRC inactive state.

In another configuration, the example apparatus 1304 also includes means for operating in a TDD mode or a HD-FDD mode, where a BWP switch delay associated with switching to the different BWP to measure the CD-SSB or the NCD-SSB is included in a time gap consideration for at least a measurement object configuration and collision handling between SSB measurement and uplink transmission.

The means may be the prioritization component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

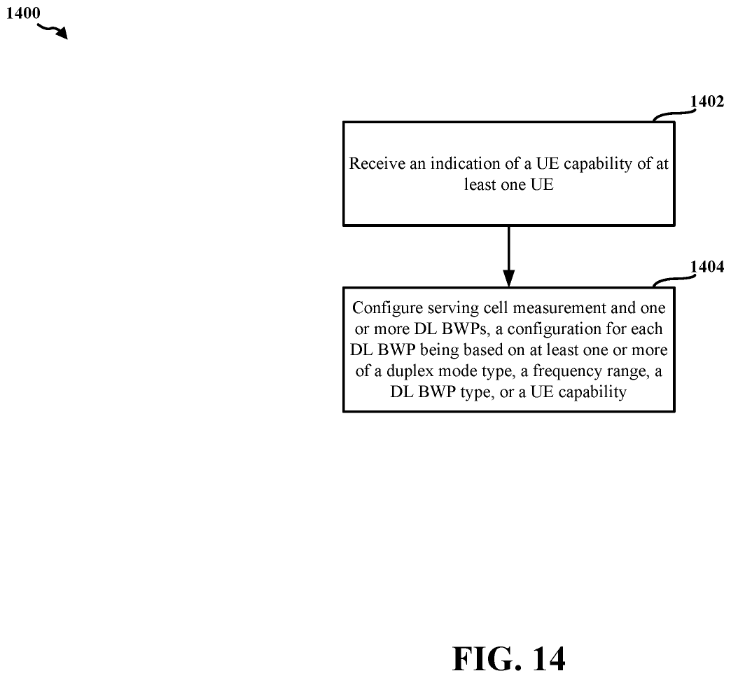

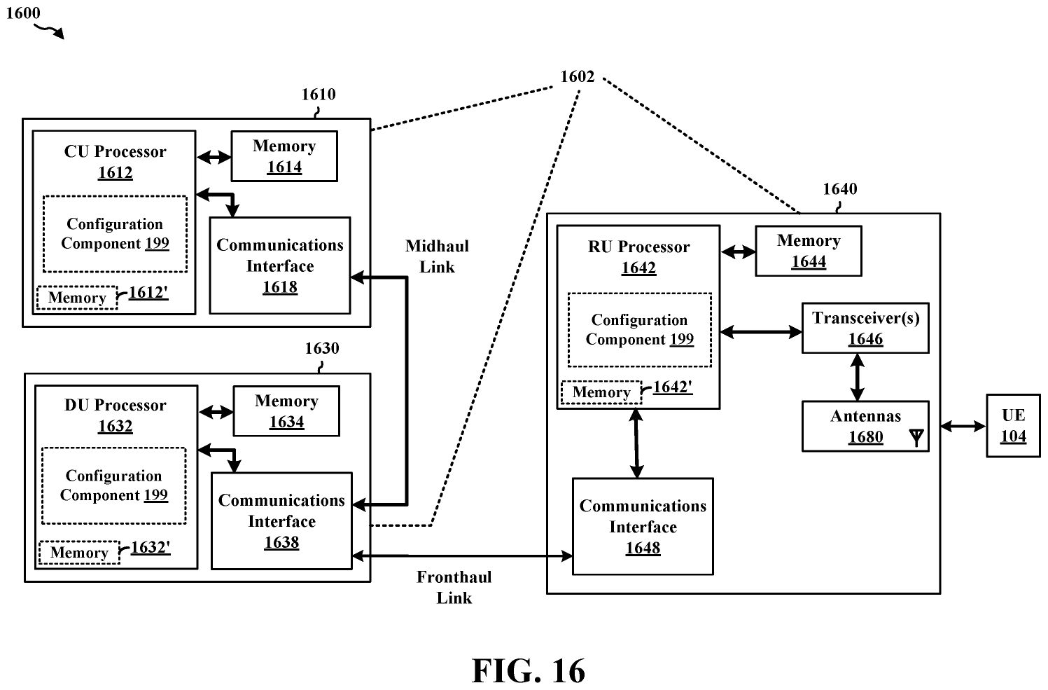

FIG. 14 is a flowchart 1400 of a method of wireless communication. The method may be performed by a network entity (e.g., the base station 102, and/or a network entity 1602 of FIG. 16). The method may facilitate improving synchronization and measurements for reduced capability UEs.

At 1402, the network entity receives an indication of a UE capability of at least one UE, as described in connection with the capability 1010 of FIG. 10. For example, the UE may be a reduced capability or a higher capability UE. The receiving of the indication, at 1402, may be performed by the configuration component 199 of the network entity 1602 of FIG. 16.

At 1404, the network entity configures serving cell measurement and one or more DL BWPs, as described in connection with the configuration 1020 of FIG. 10. In some examples, the configuration for each downlink BWP may be based on at least one or more of a duplex mode type, a frequency range, a DL BWP type, or a UE capability. In some examples, based on one or more of the duplex mode type, the frequency range, the DL BWP type, or the UE capability, the configuration of each DL BWP and a measurement object for a serving cell may include a CD-SSB, may include an NCD-SSB, or may not include an SSB of the serving cell, as described in connection with the examples of FIG. 7 and FIG. 8. The configuring, at 1404, may be performed by the configuration component 199 of the network entity 1602 of FIG. 16.

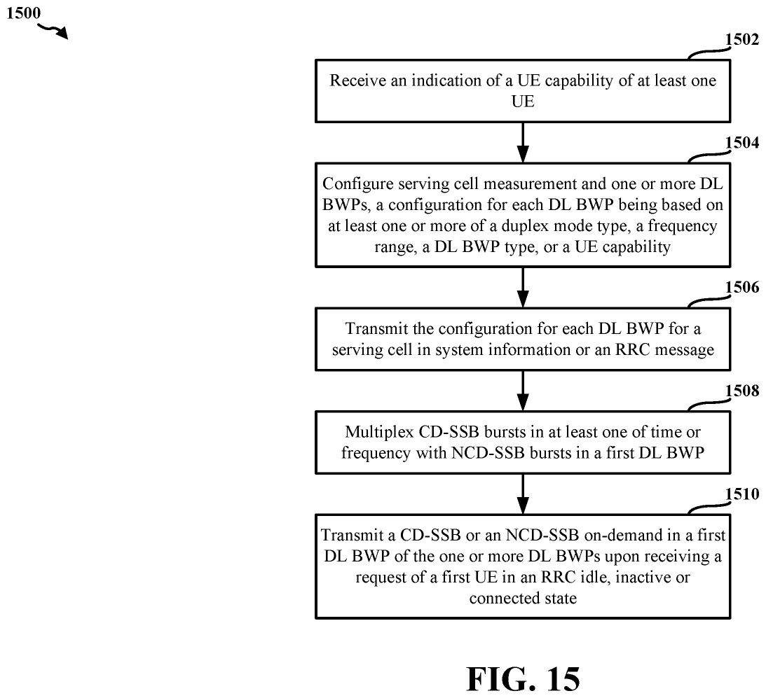

FIG. 15 is a flowchart 1500 of a method of wireless communication. The method may be performed by a network entity (e.g., the base station 102, and/or a network entity 1602 of FIG. 16). The method may facilitate improving synchronization and measurements for reduced capability UEs.

At 1502, the network entity receives an indication of a UE capability of at least one UE, as described in connection with the capability 1010 of FIG. 10. For example, the UE may be a reduced capability or a higher capability UE. The receiving of the indication, at 1502, may be performed by the configuration component 199 of the network entity 1602 of FIG. 16.

At 1504, the network entity configures serving cell measurement and one or more DL BWPs, as described in connection with the configuration 1020 of FIG. 10. In some examples, the configuration for each downlink BWP may be based on at least one or more of a duplex mode type, a frequency range, a DL BWP type, or a UE capability. In some examples, based on one or more of the duplex mode type, the frequency range, the DL BWP type, or the UE capability, the configuration of each DL BWP and a measurement object for a serving cell may include a CD-SSB, may include an NCD-SSB, or may not include an SSB of the serving cell, as described in connection with the examples of FIG. 7 and FIG. 8. The configuring, at 1504, may be performed by the configuration component 199 of the network entity 1602 of FIG. 16.

In some examples, the network entity may transmit, at 1506, the configuration for each downlink BWP for a serving cell in system information or an RRC message, as described in connection with the configuration 1020 of FIG. 10. The transmitting, at 1506, may be performed by the configuration component 199 of the network entity 1602 of FIG. 16.

As an example, the UE capability may be a reduced capability and the configuration may be for an initial DL BWP that includes one of the CD-SSB or the NCD-SSB or the configuration may be for the initial DL BWP that does not include the SSB of the serving cell, as described in connection with the examples of FIG. 7.

In some aspects, the UE capability may be a reduced capability and the configuration may be for a non-initial DL BWP that includes one of the CD-SSB or the NCD-SSB or the configuration may be for the non-initial DL BWP that does not include the SSB of the serving cell, as described in connection with the examples of FIG. 7.

In some aspects, the UE capability may be a higher capability and the configuration may be for an initial DL BWP that includes the CD-SSB or that includes the CD-SSB and the NCD-SSB of the serving cell, as described in connection with the examples of FIG. 8. In some aspects, the UE capability may be a higher capability and the configuration may be for a non-initial DL BWP for the UE in an RRC connected state and includes at least one of the CD-SSB or the NCD-SSB or the configuration may be for the non-initial DL BWP that does not include the SSB of the serving cell, as described in connection with the examples of FIG. 8.

In some aspects, the configuration, at 1504, may be for a first DL BWP that includes a CD-SSB and an NCD-SSB from a serving cell, the CD-SSB and the NCD-SSB sharing at least one of: a same primary synchronization signal sequence, a same secondary synchronization signal sequence, a PCI, a same number of SSBs transmitted in each SSB burst, a same pattern of SSBs transmitted in each SSB burst, a same transmission power, a same periodicity of an SSB burst, a same QCL resource, a same numerology for one or multiple physical signals or physical channels of the SSBs, or a same EPRE boosting ratio for the one or multiple physical signals or physical channels of the SSBs.

In some examples, the network entity may multiplex, at 1508, CD-SSB bursts in at least one of time or frequency with NCD-SSB bursts in the first DL BWP, as described in connection with the examples of FIG. 9. For example, SSB includes PSS, SSS and PBCH (which may include DMRS), e.g., as described in connection with FIG. 2C. In some aspects, a same numerology (e.g., subcarrier spacing and cyclic prefix) can be applied to all or a subset of the physical signals (PSS, SSS, DMRS of PBCH) and the physical channels (PBCH data REs without DMRS). In some aspects, EPRE boosting can be applied to all or a subset of the physical signals (PSS, SSS, DMRS of PBCH) and the physical channels (PBCH data REs without DMRS).

In some aspects, the network entity may transmit, at 1510, a CD-SSB or an NCD-SSB on-demand in a first DL BWP of the one or more DL BWPs upon receiving a request of a first UE in an RRC idle, inactive or connected state, and where the first UE has a reduced or higher capability and is allowed to access the cell, as described in connection with the CD-SSB 1034 and/or the NCD-SSB 1036 of FIG. 13.

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the configuration component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memories (e.g., the on-chip memory 1612′, the on-chip memory 1632′, and/or the on-chip memory 1642′) and/or the additional memory modules (e.g., the additional memory modules 1614, the additional memory modules 1634, and/or the additional memory modules 1644) may each be considered a computer-readable medium/memory. Each computer-readable medium/memory may be non-transitory. Each of the CU processor 1612, the DU processor 1632, the RU processor 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the configuration component 199 is configured to receive an indication of a UE capability of at least one UE. The configuration component 199 may also be configured to configure serving cell measurement and one or more DL BWPs, a configuration for each DL BWP being based on at least one or more of a duplex mode type, a frequency range, a DL BWP type, or a UE capability.

The configuration component 199 may be within one or more processors of one or more of the CU 1610, DU 1630, and the RU 1640. The configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof.

The network entity 1602 may include a variety of components configured for various functions. For example, the configuration component 199 may include one or more hardware components that perform each of the blocks of the algorithm in the flowcharts of FIG. 14 and/or FIG. 15.

In one configuration, the network entity 1602 includes means for receiving an indication of a UE capability of at least one UE. The example network entity 1602 also includes means for configuring serving cell measurement and one or more DL BWPs, a configuration for each DL BWP being based on at least one or more of a duplex mode type, a frequency range, a DL BWP type, or a UE capability.

In another configuration, the example network entity 1602 also includes means for multiplexing CD-SSB bursts in at least one of time or frequency with NCD-SSB bursts in the DL BWP.

In another configuration, the example network entity 1602 also includes means for transmitting a CD-SSB or an NCD-SSB on-demand in a first DL BWP of the one or more DL BWPs upon receiving a request of a first UE in an RRC idle, inactive or connected state, where the first UE has a reduced or higher capability and is allowed to access a serving cell.

In another configuration, the example network entity 1602 also includes means for transmitting the configuration for each DL BWP for a serving cell in system information or an RRC message.

The means may be the configuration component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

Aspects disclosed herein provide techniques for different SSB transmission in the initial/non-initial downlink BWP of different UE types (e.g., a reduced capability UE or a non-reduced capability UE) when a cell allows different UE types to access the cell. That is, when a cell supports reduced capability UE and non-reduced capability UE co-existence, different SSB transmissions in the initial/non-initial downlink BWP of the different UE type may be supported. Additionally, aspects disclosed herein provide priority rules for SSB-based measurements (e.g., for RO selection, time/frequency tracking, link recovery, RRM measurements, RLM measurements, BFD measurements, and other tasks).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising: indicating a UE capability to a network; and receiving a configuration for a measurement object and a DL BWP in system information or a RRC message, the configuration indicating that the DL BWP includes a CD-SSB, includes a NCD-SSB, or that an SSB is absent, the configuration for the measurement object and the DL BWP being based at least on one or more of a duplex mode type, a frequency range, a type of the DL BWP, or the UE capability.

Aspect 2 is the method of aspect 1, further including that the UE has a reduced capability and the configuration is for an initial DL BWP that includes one of the CD-SSB or the NCD-SSB or the configuration is for the initial DL BWP that does not include the SSB of a serving cell.

Aspect 3 is the method of aspect 1, further including that the UE has a reduced capability and the configuration is for a non-initial DL BWP that includes one of the CD-SSB or the NCD-SSB or the configuration is for the non-initial DL BWP that does not include the SSB of a serving cell.

Aspect 4 is the method of aspect 1, further including that the UE is a higher capability UE and the configuration is for an initial DL BWP that includes the CD-SSB or that includes the CD-SSB and the NCD-SSB of a serving cell.

Aspect 5 is the method of aspect 1, further including that the UE is a higher capability UE and the configuration is for a non-initial DL BWP for the UE in a RRC connected state and includes at least one of the CD-SSB or the NCD-SSB or the configuration is for the non-initial DL BWP that does not include the SSB of a serving cell.

Aspect 6 is the method of any of aspects 1 to 5, further including that the configuration is for the DL BWP that includes the CD-SSB and the NCD-SSB from a serving cell, the CD-SSB and the NCD-SSB sharing at least one of: a same primary synchronization signal sequence, a same secondary synchronization signal sequence, a PCI, a same number of SSBs transmitted in each SSB burst, a same pattern of SSBs transmitted in each SSB burst, a same transmission power, a same periodicity of an SSB burst, a same QCL resource, a same numerology for one or multiple physical signals or physical channels of the SSBs, or a same EPRE boosting ratio for the one or multiple physical signals or physical channels of the SSBs.

Aspect 7 is the method of aspect 6, further including that CD-SSB bursts are multiplexed in at least one of time or frequency with NCD-SSB bursts in the DL BWP.

Aspect 8 is the method of any of aspects 1 to 7, further including that the configuration is for the DL BWP including both the CD-SSB and the NCD-SSB from a serving cell, and the measurement object of the serving cell, the method further including: measuring all or part of SSBs in one of a CD-SSB burst or an NCD-SSB burst in a slot; and skipping a measurement of all or part of the SSBs in a different one of the CD-SSB burst or the NCD-SSB burst in the slot.

Aspect 9 is the method of any of aspects 1 to 8, further including: operating in a TDD mode or a HD-FDD mode; receiving semi-static or dynamic scheduling information for an uplink transmission; receiving a measurement object configuration defined for the SSB of a serving cell, where SSBs have an insufficient switching gap associated with the uplink transmission; and skipping transmission of the uplink transmission fully or partially based at least on a UE capability for UL cancellation and the insufficient switching gap between DL and UL in a time domain.

Aspect 10 is the method of any of aspects 1 to 8, further including: operating in a TDD mode or a HD-FDD mode; receiving semi-static or dynamic scheduling information for an uplink transmission that overlaps with SSBs of an SSB burst that is not defined by a measurement configuration for the UE; skipping measurement of one or multiple SSBs of the SSB burst that is not defined by the measurement object configured for the UE; and transmitting the uplink transmission.

Aspect 11 is the method of any of aspects 1 to 5, further including that the configuration is for the DL BWP includes the CD-SSB and does not include the NCD-SSB from a serving cell, the method further including: skipping a measurement of another NCD-SSB outside the DL BWP, the measurement being for one or more of cell selection, cell reselection, radio resource management, radio link monitoring, beam management, UL resource selection, power control, timing advance validation, link recovery, a tracking loop, or automatic gain control.

Aspect 12 is the method of any of aspects 1 to 5, further including that the configuration is for the DL BWP does not include the SSB from a serving cell, the method further includes: switching to a different BWP to measure the CD-SSB from the serving cell if the UE is in an RRC idle state; and switching to the different BWP to measure the CD-SSB or the NCD-SSB from the serving cell if the UE is in an RRC connected state or an RRC inactive state.

Aspect 13 is the method of any of aspects 1 to 12, further including: operating in a TDD mode or a HD-FDD mode, where a BWP switch delay associated with switching to the different BWP to measure the CD-SSB or the NCD-SSB is included in a time gap consideration for at least a measurement object configuration and collision handling between SSB measurement and uplink transmission.

Aspect 14 is an apparatus for wireless communication at a UE including at least one processor coupled to a memory and configured to implement any of aspects 1 to 13.

In aspect 15, the apparatus of aspect 14 further includes at least one antenna coupled to the at least one processor.

In aspect 16, the apparatus of aspect 14 or 15 further includes a transceiver coupled to the at least one processor.

Aspect 17 is an apparatus for wireless communication including means for implementing any of aspects 1 to 13.

In aspect 18, the apparatus of aspect 17 further includes at least one antenna coupled to the means to perform the method of any of aspects 1 to 13.

In aspect 19, the apparatus of aspect 17 or 18 further includes a transceiver coupled to the means to perform the method of any of aspects 1 to 13.

Aspect 20 is a non-transitory computer-readable storage medium storing computer executable code, where the code, when executed, causes a processor to implement any of aspects 1 to 13.

Aspect 21 is a method of wireless communication at a network entity, including: receiving an indication of a UE capability of at least one UE; and configuring serving cell measurement and one or more DL BWPs, a configuration for each DL BWP being based on at least one or more of a duplex mode type, a frequency range, a DL BWP type, or a UE capability.

Aspect 22 is the method of aspect 21, further including that, based on one or more of the duplex mode type, the frequency range, the DL BWP type, or the UE capability, the configuration of each DL BWP and a measurement object for a serving cell includes a CD-SSB, includes an NCD-SSB, or does not include an SSB of the serving cell.

Aspect 23 is the method of any of aspects 21 and 22, further including that the UE capability is a reduced capability and the configuration is for an initial DL BWP that includes one of the CD-SSB or the NCD-SSB or the configuration is for the initial DL BWP that does not include the SSB of the serving cell.

Aspect 24 is the method of any of aspects 21 and 22, further including that the UE capability is a reduced capability and the configuration is for a non-initial DL BWP that includes one of the CD-SSB or the NCD-SSB or the configuration is for the non-initial DL BWP that does not include the SSB of the serving cell.

Aspect 25 is the method of any of aspects 21 and 22, further including that the UE capability is a higher capability and the configuration is for an initial DL BWP that includes the CD-SSB or that includes the CD-SSB and the NCD-SSB of the serving cell.

Aspect 26 is the method of any of aspects 21 and 22, further including that the UE capability is a higher capability and the configuration is for a non-initial DL BWP for the at least one UE in an RRC connected state and includes at least one of the CD-SSB or the NCD-SSB or the configuration is for the non-initial DL BWP that does not include the SSB of the serving cell.

Aspect 27 is the method of any of aspects 21 to 26, further including that the configuration is for a first DL BWP of the one or more DL BWPs that includes a CD-SSB and a NCD-SSB from a serving cell, the CD-SSB and the NCD-SSB sharing at least one of: a same primary synchronization signal sequence, a same secondary synchronization signal sequence, a PCI, a same number of SSBs transmitted in each SSB burst, a same pattern of SSBs transmitted in each SSB burst, a same transmission power, a same periodicity of an SSB burst, a same quasi co-location (QCL) resource, a same numerology for one or multiple physical signals or physical channels of the SSBs, or a same EPRE boosting ratio for the one or multiple physical signals or physical channels of the SSBs.

Aspect 28 is the method of any of aspects 21 to 27, further including: multiplexing CD-SSB bursts in at least one of time or frequency with NCD-SSB bursts in the first DL BWP.

Aspect 29 is the method of any of aspects 21 to 24, 26, and 27, further including: transmitting a CD-SSB or an NCD-SSB on-demand in a first DL BWP of the one or more DL BWPs upon receiving a request of a first UE in an RRC idle, inactive or connected state, where the first UE has a reduced or higher capability and is allowed to access a serving cell.

Aspect 30 is the method of any of aspects 21 to 29, further including: transmitting the configuration for each DL BWP for a serving cell in system information or an RRC message.

Aspect 31 is an apparatus for wireless communication at a network entity including at least one processor coupled to a memory and configured to implement any of aspects 21 to 30.

In aspect 32, the apparatus of aspect 31 further includes at least one antenna coupled to the at least one processor.

In aspect 33, the apparatus of aspect 31 or 32 further includes a transceiver coupled to the at least one processor.

Aspect 34 is an apparatus for wireless communication including means for implementing any of aspects 21 to 30.

In aspect 35, the apparatus of aspect 34 further includes at least one antenna coupled to the means to perform the method of any of aspects 21 to 30.

In aspect 36, the apparatus of aspect 34 or 35 further includes a transceiver coupled to the means to perform the method of any of aspects 21 to 30.

Aspect 37 is a non-transitory computer-readable storage medium storing computer executable code, where the code, when executed, causes a processor to implement any of aspects 21 to 30.

What is claimed is:

1. An apparatus for wireless communication at a user equipment (UE), comprising:
a memory; and
at least one processor coupled to the memory and configured to:
indicate a UE capability to a network; and
receive a configuration for a measurement object and a downlink (DL) bandwidth part (BWP), the configuration indicating that the DL BWP includes a cell-defining synchronization signal block (CD-SSB), includes a non-CD-SSB (NCD-SSB), or that an SSB is absent, the configuration for the measurement object and the DL BWP being based at least on one or more of a duplex mode type, a frequency range, a type of the DL BWP, or the UE capability.

2. The apparatus of claim 1, wherein the UE has a reduced capability and the configuration is for an initial DL BWP that includes one of the CD-SSB or the NCD-SSB or the configuration is for the initial DL BWP that does not include the SSB of a serving cell.

3. The apparatus of claim 1, wherein the UE has a reduced capability and the configuration is for a non-initial DL BWP that includes one of the CD-SSB or the NCD-SSB or the configuration is for the non-initial DL BWP that does not include the SSB of a serving cell.

4. The apparatus of claim 1, wherein the UE is a higher capability UE and the configuration is for an initial DL BWP that includes the CD-SSB or that includes the CD-SSB and the NCD-SSB of a serving cell.

5. The apparatus of claim 1, wherein the UE is a higher capability UE and the configuration is for a non-initial DL BWP for the UE in a radio resource control (RRC) connected state and includes at least one of the CD-SSB or the NCD-SSB or the configuration is for the non-initial DL BWP that does not include the SSB of a serving cell.

6. The apparatus of claim 1, wherein the configuration is for the DL BWP that includes the CD-SSB and the NCD-SSB from a serving cell, the CD-SSB and the NCD-SSB sharing at least one of:
a same primary synchronization signal sequence,
a same secondary synchronization signal sequence,
a physical cell identifier (PCI),
a same number of SSBs transmitted in each SSB burst,
a same pattern of SSBs transmitted in each SSB burst,
a same transmission power,
a same periodicity of an SSB burst,
a same quasi co-location (QCL) resource,
a same numerology for one or multiple physical signals or physical channels of the SSBs, or
a same energy per resource element (EPRE) boosting ratio for the one or multiple physical signals or physical channels of the SSBs.

7. The apparatus of claim 6, wherein CD-SSB bursts are multiplexed in at least one of time or frequency with NCD-SSB bursts in the DL BWP.

8. The apparatus of claim 1, wherein the configuration is for the DL BWP including both the CD-SSB and the NCD-SSB from a serving cell, and the measurement object of the serving cell, the at least one processor further configured to:
measure all or part of SSBs in one of a CD-SSB burst or an NCD-SSB burst in a slot; and
skip a measurement of all or part of the SSBs in a different one of the CD-SSB burst or the NCD-SSB burst in the slot.

9. The apparatus of claim 1, wherein the at least one processor is further configured to:
operate in a time division duplex (TDD) mode or a half-duplex frequency division duplex (HD-FDD) mode;
receive semi-static or dynamic scheduling information for an uplink transmission;
receive a measurement object configuration defined for the SSB of a serving cell,
wherein SSBs have an insufficient switching gap associated with the uplink transmission; and
skip transmission of the uplink transmission fully or partially based at least on the UE capability for uplink (UL) cancellation and the insufficient switching gap between DL and UL in a time domain.

10. The apparatus of claim 1, wherein the at least one processor is further configured to:
operate in a time division duplex (TDD) mode or a half-duplex frequency division duplex (HD-FDD) mode;
receive semi-static or dynamic scheduling information for an uplink transmission,
which overlaps with SSBs of a SSB burst that is not defined by a measurement configuration for the UE;
skip measurement of one or multiple SSBs of the SSB burst that is not defined by the measurement object configured for the UE; and
transmit the uplink transmission.

11. The apparatus of claim 1, wherein the configuration is for the DL BWP includes the CD-SSB and does not include the NCD-SSB from a serving cell, the at least one processor further configured to:
skip a measurement of another NCD-SSB outside the DL BWP, the measurement being for one or more of cell selection, cell reselection, radio resource management, radio link monitoring, beam management, uplink resource selection, power control, timing advance validation, link recovery, a tracking loop, or automatic gain control.

12. The apparatus of claim 1, wherein the configuration is for the DL BWP does not include the SSB from a serving cell, the at least one processor further configured to:
switch to a different BWP to measure the CD-SSB from the serving cell if the UE is in a radio resource control (RRC) idle state; and
measure the CD-SSB or the NCD-SSB from the serving cell if the UE is in an RRC connected state or an RRC inactive state, after the switch to the different BWP.

13. The apparatus of claim 12, wherein the at least one processor is further configured to:
operate in a time division duplex (TDD) mode or a half-duplex frequency division duplex (HD-FDD) mode, wherein a BWP switch delay associated with switching to the different BWP to measure the CD-SSB or the NCD-SSB is included in a time gap consideration for at least a measurement object configuration and collision handling between SSB measurement and uplink transmission.

14. The apparatus of claim 1, wherein the at least one processor is further configured to:
receive the configuration for the measurement object and the DL BWP in system information or a radio resource control (RRC) message.

15. The apparatus of claim 1, further comprising a transceiver coupled to the at least one processor.

16. A method of wireless communication at a user equipment (UE), comprising:
indicating a UE capability to a network; and
receiving a configuration for a measurement object and a downlink (DL) bandwidth part (BWP), the configuration indicating that the DL BWP includes a cell-defining synchronization signal block (CD-SSB), includes a non-CD-SSB (NCD-SSB),
or that an SSB is absent, the configuration for the measurement object and the DL BWP being based at least on one or more of a duplex mode type, a frequency range, a type of the DL BWP, or the UE capability.

17. An apparatus for wireless communication at a network entity, comprising:
a memory; and
at least one processor coupled to the memory and configured to:
receive an indication of a user equipment (UE) capability of at least one UE; and
configure serving cell measurement and one or more downlink (DL) bandwidth parts (BWPs), a configuration for each DL BWP being based on at least one or more of a duplex mode type, a frequency range, a DL BWP type, or the UE capability.

18. The apparatus of claim 17, wherein, based on one or more of the duplex mode type, the frequency range, the DL BWP type, or the UE capability, the configuration of each DL BWP and a measurement object for a serving cell includes a cell-defining synchronization signal block (CD-SSB), includes a non-CD-SSB (NCD-SSB), or does not include an SSB of the serving cell.

19. The apparatus of claim 18, wherein the UE capability is a reduced capability and the configuration is for an initial DL BWP that includes one of the CD-SSB or the NCD-SSB or the configuration is for the initial DL BWP that does not include the SSB of the serving cell.

20. The apparatus of claim 18, wherein the UE capability is a reduced capability and the configuration is for a non-initial DL BWP that includes one of the CD-SSB or the NCD-SSB or the configuration is for the non-initial DL BWP that does not include the SSB of the serving cell.

21. The apparatus of claim 18, wherein the UE capability is a higher capability and the configuration is for an initial DL BWP that includes the CD-SSB or that includes the CD-SSB and the NCD-SSB of the serving cell.

22. The apparatus of claim 18, wherein the UE capability is a higher capability and the configuration is for a non-initial DL BWP for the at least one UE in a radio resource control (RRC) connected state and includes at least one of the CD-SSB or the NCD-SSB or the configuration is for the non-initial DL BWP that does not include the SSB of the serving cell.

23. The apparatus of claim 17, wherein the configuration is for a first DL BWP of the one or more DL BWPs that includes a cell-defining synchronization signal block (CD-SSB) and a non-CD-SSB (NCD-SSB) from a serving cell, the CD-SSB and the NCD-SSB sharing at least one of:
a same primary synchronization signal sequence,
a same secondary synchronization signal sequence,
a physical cell identifier (PCI),
a same number of SSBs transmitted in each SSB burst,
a same pattern of SSBs transmitted in each SSB burst,
a same transmission power,
a same periodicity of an SSB burst,
a same quasi co-location (QCL) resource,
a same numerology for one or multiple physical signals or physical channels of the SSBs, or
a same energy per resource element (EPRE) boosting ratio for the one or multiple physical signals or physical channels of the SSBs.

24. The apparatus of claim 23, wherein the at least one processor is further configured to:
multiplex CD-SSB bursts in at least one of time or frequency with NCD-SSB bursts in the first DL BWP.

25. The apparatus of claim 17, wherein the at least one processor is further configured to:
transmit a cell-defining synchronization signal block (CD-SSB) or a non-CD-SSB (NCD-SSB) on-demand in a first DL BWP of the one or more DL BWPs upon receiving a request of a first UE in a radio resource control (RRC) idle, inactive or connected state,
wherein the first UE has a reduced or higher capability and is allowed to access a serving cell.

26. The apparatus of claim 17, wherein the at least one processor is further configured to:
transmit the configuration for each DL BWP for a serving cell in system information or a radio resource control (RRC) message.

27. The apparatus of claim 17, further comprising a transceiver coupled to the at least one processor.

28. A method of wireless communication at a network entity, comprising:
receiving an indication of a user equipment (UE) capability of at least one UE; and
configuring serving cell measurement and one or more downlink (DL) bandwidth parts (BWPs), a configuration for each DL BWP being based on at least one or more of a duplex mode type, a frequency range, a DL BWP type, or a UE capability.

29. The method of claim 28, wherein, based on one or more of the duplex mode type, the frequency range, the DL BWP type, or the UE capability, the configuration of each DL BWP and a measurement object for a serving cell includes a cell-defining synchronization signal block (CD-SSB), includes a non-CD-SSB (NCD-SSB), or does not include an SSB of the serving cell.
